(19) United States
(12) Patent Application Publication
(10) Pub. No.: US 2025/0321370 A1
(43) Pub. Date: Oct. 16, 2025

(54) RETARDATION FILM, LAMINATED OPTICAL FILM, OPTICAL ARTICLE, AND VIRTUAL REALITY DISPLAY DEVICE

(71) Applicant: FUJIFILM Corporation, Tokyo (JP)

(72) Inventor: Ryuji SANETO, Minamiashigara-shi (JP)

(73) Assignee: FUJIFILM Corporation, Tokyo (JP)

(21) Appl. No.: 19/248,560

(22) Filed: Jun. 25, 2025

Related U.S. Application Data
(63) Continuation of application No. PCT/JP2024/000040, filed on Jan. 5, 2024.

(30) Foreign Application Priority Data
Jan. 17, 2023 (JP) 2023-005277
Nov. 1, 2023 (JP) 2023-187368

(51) Int. Cl. G02B 5/30; G02B 1/11

(52) U.S. Cl. CPC G02B 5/3083; G02B 1/11

(57) ABSTRACT

An object of the present invention is to provide a retardation film, a laminated optical film, an optical article, and a virtual reality display device in which occurrence of a ghost is small in a case of being used in a virtual reality display device, an electronic finder, or the like. A retardation film according to an aspect of the present invention includes a light interference layer, and a retardation layer, in which the light interference layer and the retardation layer are disposed adjacent to each other in this order to form the retardation film, and a film thickness of the light interference layer satisfies 60 nm to 110 nm or 230 nm to 330 nm.

### CROSS-REFERENCE TO RELATED APPLICATIONS

This application is a Continuation of PCT International Application No. PCT/JP2024/000040, filed on Jan. 5, 2024, which claims priority under 35 U.S.C. § 119(a) to Japanese Patent Application No. 2023-005277, filed on Jan. 17, 2023, and Japanese Patent Application No. 2023-187368, filed on Nov. 1, 2023. Each of the above applications is hereby expressly incorporated by reference, in its entirety, into the present application.

### BACKGROUND OF THE INVENTION

### 1. Field of the Invention

The present invention relates to a retardation film, a laminated optical film, an optical article, and a virtual reality display device.

### 2. Description of the Related Art

A reflective polarizer is a polarizer having a function of reflecting one polarized light in incidence ray and transmitting the other polarized light. Reflected light and transmitted light due to the reflective polarizer are in a polarization state of being orthogonal to each other. Here, the state of polarized light orthogonal to each other denotes a state of polarized light both positioned at antipodal points on the Poincare sphere, and for example, linearly polarized light orthogonal to each other, and clockwise circularly polarized light and counterclockwise circularly polarized light are in the corresponding state.

As a linear reflective polarizer in which the transmitted light and the reflected light are converted into linearly polarized light, for example, a film obtained by stretching a dielectric multi-layer film, as described in JP2011-053705A, and a wire grid polarizer as described in JP2015-028656A have been known.

In addition, as a reflective circular polarizer in which the transmitted light and the reflected light are converted into circularly polarized light, for example, a film having a light reflecting layer obtained by immobilizing a cholesteric liquid crystalline phase, as described in JP6277088B, has been known.

The reflective polarizer is used for the purpose of extracting only specific polarized light from incidence rays or separating incidence rays into two polarized light. For example, in a liquid crystal display device, the reflective polarizer is used as a luminance-improving film which enhances light utilization efficiency by reflecting unnecessary polarized light from backlight and reusing the light. In addition, in a liquid crystal projector, the reflective polarizer is also used as a beam splitter which separates light from a light source into two linearly polarized light and supplies each of the two linearly polarized light to a liquid crystal panel.

In addition, in recent years, a method of using a reflective polarizer has been suggested for the purpose of generating a virtual image or a real image by partially reflecting external light and/or light from an image display device. For example, JP2017-227720A discloses an in-vehicle room mirror which reflects light from behind using the reflective polarizer. In addition, JP2003-504663A discloses a method of reducing the size and thickness of a display unit by disposing a linear reflective polarizer and a half mirror (semi-transparent mirror) in a condenser lens system in a virtual reality display device (head-mounted display) and further disposing a retardation film having a function of a ¼ wavelength plate therebetween.

### SUMMARY OF THE INVENTION

According to the examination by the present inventors, in the virtual reality display device described in JP2003-504663A, ghosts are observed, and there is room for further improvement.

The present invention has been made in view of the above-described problems, and an object to be achieved by the present invention is to provide a retardation film, a laminated optical film, an optical article, and a virtual reality display device in which occurrence of a ghost is small in a case of being used in a virtual reality display device, an electronic finder, and the like.

As a result of intensive studies repeatedly conducted by the present inventors on the above-described object, it has been found that the above-described object can be achieved by the following configurations.

[1] A retardation film comprising:
a light interference layer; and
a retardation layer,
in which the light interference layer and the retardation layer are disposed adjacent to each other in this order to form the retardation film, and
a film thickness of the light interference layer is 60 nm to 110 nm or 230 nm to 330 nm.

[2] The retardation film according to [1],
in which a refractive index of the light interference layer in an in-plane direction is 1.50 to 1.70.

[3] The retardation film according to [1],
in which a refractive index of the light interference layer in an in-plane direction is 1.53 to 1.59.

[4] The retardation film according to any one of [1] to [3], further comprising:
an adhesive layer,
in which the adhesive layer, the light interference layer, and the retardation layer are disposed adjacent to each other in this order to form the retardation film, and
in a case where a refractive index of the adhesive layer is nA and an average refractive index of the retardation layer is nL, a refractive index nI of the light interference layer in an in-plane direction satisfies (nA×nL)^{1/2}−0.03≤nI≤(nA×nL)^{1/2}+0.03.

[5] The retardation film according to any one of [1] to [4], in which the light interference layer is a photo-alignment film.

[6] The retardation film according to any one of [1] to [4], in which the light interference layer is a C-plate.

[7] The retardation film according to [6],
in which a compound having a cinnamoyl group is present between the C-plate and the retardation layer.

[8] The retardation film according to any one of [1] to [4],
in which the light interference layer is a hardcoat layer.

[9] A laminated optical film comprising, at least:
a retardation film; and
a linear reflective polarizer,
in which the retardation film is the retardation film according to any one of [1] to [8], and the linear reflective polarizer is disposed on a side of the retardation layer opposite to the light interference layer.

[10] The laminated optical film according to [9], further comprising:
a linear polarizer.

[11] The laminated optical film according to [10],
in which the linear polarizer includes a light absorption anisotropic layer which contains at least a liquid crystal compound and a dichroic substance.

[12] The laminated optical film according to [9], further comprising:
a positive C-plate.

[13] The laminated optical film according to [9], further comprising:
an antireflection layer.

[14] The laminated optical film according to [13],
in which the antireflection layer is a moth-eye film or an AR film.

[15] The laminated optical film according to [9], further comprising:
a resin base material having a peak temperature of a loss tangent tan δ of 170° C. or lower.

[16] An optical article comprising:
the laminated optical film according to any one of [9] to [15]; and
a lens.

[17] A virtual reality display device comprising:
the optical article according to [16].

According to the present invention, it is possible to provide a retardation film, a laminated optical film, an optical article, and a virtual reality display device in which occurrence of a ghost is small in a case of being used in a virtual reality display device, an electronic finder, or the like.

### BRIEF DESCRIPTION OF THE DRAWINGS

FIG. 1 is a schematic diagram showing an example of a retardation film according to the present invention.

FIG. 2 is a schematic diagram showing another example of the retardation film according to the present invention.

FIG. 3 is an example of a virtual reality display device formed using a laminated optical film according to the present invention.

FIG. 4 is an example of the virtual reality display device formed using the laminated optical film according to the present invention.

FIG. 5 is a schematic diagram showing an example of the laminated optical film according to the present invention.

FIG. 6 is a diagram for describing an action of a retardation film in the related art.

FIG. 7 is a diagram for describing the action of the retardation film according to the present invention.

FIG. 8 is another example of the virtual reality display device using the retardation film according to the present invention.

### DESCRIPTION OF THE PREFERRED EMBODIMENTS

Hereinafter, the present invention will be described in detail. The description of the configuration requirements described below may be made based on representative embodiments and specific examples, but the present invention is not limited to such embodiments.

In addition, in the present specification, a numerical range shown using “to” indicates a range including numerical values described before and after “to” as a lower limit and an upper limit.

In the present specification, a term “orthogonal” does not denote 90° in a strict sense, but denotes 90°±10°, preferably 90°±5°. In addition, a term “parallel” does not denote 0° in a strict sense, but denotes 0°±10°, preferably 0°±5°. Furthermore, a term “45°” does not denote 45° in a strict sense, but denotes 45°±10°, preferably 45°±5°.

In the present specification, a term “absorption axis” denotes a polarization direction in which absorbance is maximized in a plane in a case where linearly polarized light is incident. In addition, a term “reflection axis” denotes a polarization direction in which a reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which a refractive index is maximized in a plane.

In the present specification, a retardation denotes an in-plane retardation unless otherwise specified, and is referred to as Re(λ). Here, Re(λ) represents an in-plane retardation at a wavelength λ, and the wavelength λ is 550 nm unless otherwise specified.

In addition, the retardation at the wavelength λ in the thickness direction is described as Rth(λ) in the present specification, and the wavelength λ is set to 550 nm unless otherwise specified.

As Re(λ) and Rth(λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan,
a slow axis direction) (°),
Re(λ)=R0 (λ), and
“Rth(λ)=((nx+ny)/2−nz)×d” are calculated.

### [Retardation Film]

A retardation film according to an embodiment of the present invention includes a light interference layer, and a retardation layer, in which the light interference layer and the retardation layer are disposed adjacent to each other in this order to form the retardation film, and a film thickness of the light interference layer is 60 nm to 110 nm or 230 nm to 330 nm.

Hereinafter, the retardation film according to the embodiment of the present invention will be described in detail with reference to the accompanying drawings.

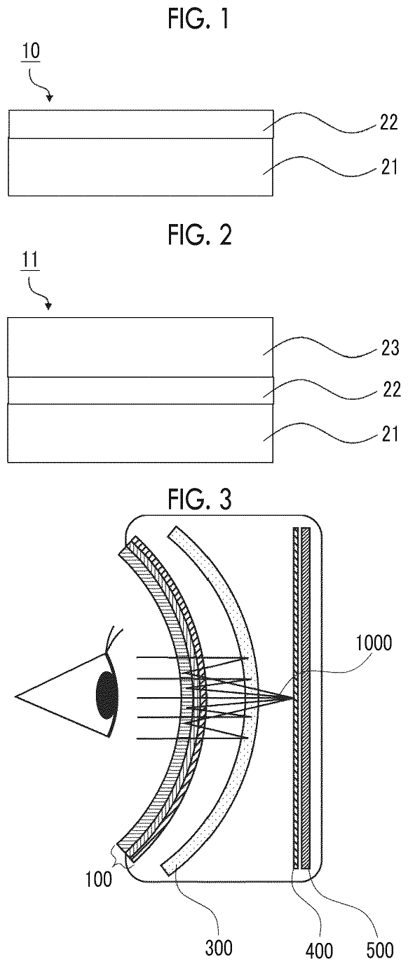

FIG. 1 is a schematic cross-sectional diagram showing an example of a configuration of a retardation film 10. In the aspect shown in FIG. 1, the retardation film 10 is composed of a retardation layer 21 and a light interference layer 22, and the retardation layer 21 and the light interference layer 22 are disposed adjacent to each other.

The retardation film according to the embodiment of the present invention can be used for a laminated optical film. The laminated optical film can be used for an optical article used in a virtual reality display device. In a case where the retardation film has the above-described configuration and the film thickness of the above-described light interference layer is set to satisfy the above-described relationship, an antireflection effect can be imparted. As a result, in the configuration in which the light interference layer in the related art is not provided, it is possible to suppress reflected light generated by the interface reflection between the retardation layer and the layer (for example, the adhesive layer and the lens) adjacent to the retardation layer. Here, in a case where the circularly polarized light is reflected from the interface, the rotation direction of the circularly polarized light changes (for example, the right circularly polarized light is changed to the left circularly polarized light by the interface reflection). Since the rotation direction of the circularly polarized light reflected from the interface is changed, this is one of the causes of the occurrence of the ghost. Therefore, it is considered that the occurrence of ghosts can be suppressed by suppressing the interface reflection.

The retardation film according to the embodiment of the present invention may include an adhesive layer for bonding the retardation film to a lens. FIG. 2 is a schematic cross-sectional diagram showing an example of a configuration of a retardation film 11. In the aspect shown in FIG. 2, the retardation film 11 is composed of the retardation layer 21, the light interference layer 22, and an adhesive layer 23, and the retardation layer 21, the light interference layer 22, and the adhesive layer 23 are disposed adjacent to each other.

Hereinafter, the action of the retardation film according to the embodiment of the present invention will be described in more detail.

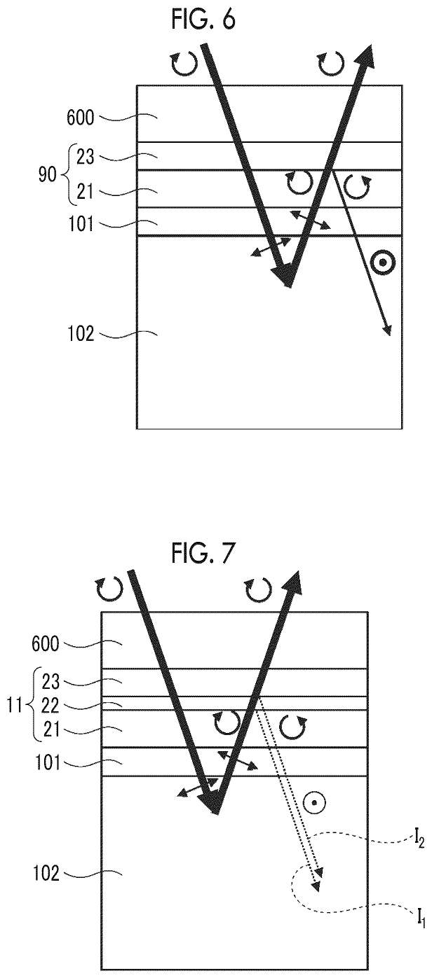

First, a configuration in which the light interference layer in the related art is not provided will be described with reference to FIG. 6.

In the example shown in FIG. 6, a retardation film 90 including the retardation layer 21 and the adhesive layer 23 is laminated on a lens 600 on the adhesive layer 23 side, and a linear reflective polarizer 102 is laminated on the retardation layer 21 side with an adhesive layer 101 interposed therebetween. Such a configuration corresponds to an optical article used in a virtual reality display device described below, and is used as a reciprocating optical system (folding optical system) in combination with a half mirror. In a case of being used as a reciprocating optical system, an upper side (lens 600 side) in FIG. 6 is an image display device side, and a lower side (linear reflective polarizer 102 side) is a visually recognizable side.

For example, in a case where right circularly polarized light is incident from the lens 600 side, the right circularly polarized light transmitted through the lens 600 and the adhesive layer 23 is converted into linearly polarized light by the retardation layer 21. As an example, the right circularly polarized light is described as being converted into linearly polarized light in the left-right direction in the drawing. The linearly polarized light transmits through the adhesive layer 101 and is incident into the linear reflective polarizer 102. For example, in a case where the linear reflective polarizer 102 reflects linearly polarized light in the left-right direction in the drawing and transmits linearly polarized light in a direction perpendicular to the paper surface in the drawing, the linearly polarized light in the left-right direction incident on the linear reflective polarizer 102 is reflected. The reflected linearly polarized light in the left-right direction transmits through the adhesive layer 101 and is incident into the retardation layer 21. The retardation layer 21 converts linearly polarized light in the left-right direction into right circularly polarized light and transmits the light. The right circularly polarized light is transmitted through the adhesive layer 23 and the lens 600. The transmitted light is incident on, for example, a half mirror.

Here, a part of the right circularly polarized light that is reflected by the linear reflective polarizer 102 and is converted by the retardation layer 21 is reflected from the interface between the retardation layer 21 and the adhesive layer 23. In addition, even in a configuration in which the adhesive layer 23 is not provided, the circularly polarized light is reflected from the interface between the retardation layer 21 and the other layer. The rotation direction of the right circularly polarized light reflected from the interface changes in the opposite direction. That is, the right circularly polarized light reflected from the interface is converted into left circularly polarized light. The left circularly polarized light is converted into linearly polarized light in a direction perpendicular to the paper surface in the drawing by the retardation layer 21. This linearly polarized light transmits through the adhesive layer 101 and is incident into the linear reflective polarizer 102. However, since the linear reflective polarizer 102 has a transmission axis in a direction perpendicular to the paper surface, the linearly polarized light in the direction perpendicular to the paper surface transmits through the linear reflective polarizer 102 and is emitted to the visually recognizable side. As described above, in the configuration of the related art, unnecessary light reflected from the interface is emitted to the visually recognizable side, and thus, the unnecessary light is visually recognized as a ghost.

Next, a configuration in which a retardation film according to the embodiment of the present invention having a light interference layer is used will be described with reference to FIG. 7.

In the example shown in FIG. 7, the retardation film 11 including the retardation layer 21, the light interference layer 22, and the adhesive layer 23 is laminated on the lens 600 on the adhesive layer 23 side, and the linear reflective polarizer 102 is laminated on the retardation layer 21 side with the adhesive layer 101 interposed therebetween. Such a configuration corresponds to an optical article used in a virtual reality display device described below, and is used as a reciprocating optical system (folding optical system) in combination with a half mirror. In a case of being used as a reciprocating optical system, an upper side (lens 600 side) in FIG. 7 is an image display device side, and a lower side (linear reflective polarizer 102 side) is a visually recognizable side.

For example, in a case where right circularly polarized light is incident from the lens 600 side, the right circularly polarized light transmitted through the lens 600, the adhesive layer 23, and the light interference layer 22 is converted into linearly polarized light by the retardation layer 21. As an example, the right circularly polarized light is described as being converted into linearly polarized light in the left-right direction in the drawing. The linearly polarized light transmits through the adhesive layer 101 and is incident into the linear reflective polarizer 102. For example, in a case where the linear reflective polarizer 102 reflects linearly polarized light in the left-right direction in the drawing and transmits linearly polarized light in a direction perpendicular to the paper surface in the drawing, the linearly polarized light in the left-right direction incident on the linear reflective polarizer 102 is reflected. The reflected linearly polarized light in the left-right direction transmits through the adhesive layer 101 and is incident into the retardation layer 21. The retardation layer 21 converts linearly polarized light in the left-right direction into right circularly polarized light and transmits the light. The right circularly polarized light transmits through the light interference layer 22, the adhesive layer 23, and the lens 600. The transmitted light is incident on, for example, a half mirror.

In addition, a part of the right circularly polarized light that is reflected from the linear reflective polarizer 102 and is converted by the retardation layer 21 is reflected from the interface between the retardation layer 21 and the light interference layer 22 (in the drawing, reflected light I₁). In addition, another part of the right circularly polarized light is also reflected from the interface between the light interference layer 22 and the adhesive layer 23 (in the drawing, reflected light I₂). The rotation directions of the reflected light I₁ and I₂ that are right circularly polarized light reflected from each interface change in opposite directions. That is, the reflected light I₁ and I₂ which are the right circularly polarized light reflected from the interface are changed to left circularly polarized light. The reflected light I₁ and I₂ which are left circularly polarized light are converted into linearly polarized light in a direction perpendicular to the paper surface in the drawing by the retardation layer 21. This linearly polarized light transmits through the adhesive layer 101 and is incident into the linear reflective polarizer 102. However, since the linear reflective polarizer 102 has a transmission axis in a direction perpendicular to the paper surface, the linearly polarized light in the direction perpendicular to the paper surface transmits through the linear reflective polarizer 102 and is emitted to the visually recognizable side.

Here, the reflected light I₁ reflected from the interface between the retardation layer 21 and the light interference layer 22 and the reflected light I₂ reflected from the interface between the light interference layer 22 and the adhesive layer 23 have different optical path lengths, and thus interference occurs. In some cases, the reflected light I₁ and the reflected light I₂ interfere constructively due to a difference between the optical path length of the reflected light I₁ and the optical path length of the reflected light I₂ (that is, the amount of phase shift), and in some cases, the reflected light I₁ and the reflected light I₂ interfere destructively. However, in the present invention, by setting the film thickness of the light interference layer 22 to 60 nm to 110 nm or 230 nm to 330 nm, destructive interference of the reflected light I₁ and the reflected light I₂ occurs, and unnecessary light reflected from the interface can be prevented from being emitted to the visually recognizable side, and thus the ghost can be reduced.

The film thickness of the light interference layer 22 is defined such that, in consideration of the fact that, in the case of interface reflection, light is incident on the interface from the front and oblique directions, and the vicinity of the front surface is particularly important, the fact that the contribution of light having a wavelength of approximately 550 nm is large with respect to the visibility of the ghost, the refractive index of the light interference layer 22, and the like, in the vicinity of the front surface and the wavelength of approximately 550 nm, the reflected light I₁ and the reflected light I₂ interfere destructively, that is, the phases of the reflected light I₁ and the reflected light I₂ are shifted by approximately λ/2 or approximately 3λ/2.

### [Retardation Layer]

The retardation layer used in the present invention is a retardation plate having a function of converting linearly polarized light having a specific wavelength into circularly polarized light (or converting circularly polarized light into linearly polarized light). More specifically, the λ/4 plate is a plate in which the in-plane retardation Re at a predetermined wavelength λ nm is λ/4 (or an odd multiple thereof).

An in-plane retardation (Re(550)) of the retardation layer at a wavelength of 550 nm may have an error of approximately 25 nm based on an ideal value (137.5 nm), and is, for example, preferably 110 to 160 nm and more preferably 120 to 150 nm.

The retardation layer used in the present invention more preferably exhibits characteristics of a λ/4 plate at each wavelength in the visible light range, and such a retardation layer is particularly referred to as a broadband λ/4 plate. In the broadband λ/4 plate, it is preferable that an in-plane retardation (Re(λ)) at a wavelength of 2 nm satisfies Expressions (A) and (B).

$$Re ( 450 ) / Re ( 550 ) < 1. \qquad Expression ( A )$$

$$Re ( 650 ) / Re ( 550 ) \geq 1. \qquad Expression ( B )$$

Re(450) represents an in-plane retardation of the λ/4 plate at a wavelength of 450 nm, Re(550) represents an in-plane retardation of the λ/4 plate at a wavelength of 550 nm, and Re(650) represents an in-plane retardation of the λ/4 plate at a wavelength of 650 nm.

The retardation layer used in the present invention may be configured by a single-layer retardation layer, or may be configured by laminating two or more retardation layers by a method such as bonding or sequential formation. The retardation layer described herein is a layer exhibiting optical anisotropy. Examples of the retardation layer include a layer in which at least two of nx, ny, or nz are different. nx represents a refractive index in a direction (in-plane direction) perpendicular to the thickness direction of the retardation layer and in a direction in which the maximum refractive index is provided. ny represents a refractive index in a direction orthogonal to the direction of nx, which is an in-plane direction of the retardation layer. nz represents a refractive index of the retardation layer in a thickness direction.

The material constituting the retardation layer used in the present invention is not particularly limited, and examples thereof include a liquid crystal compound and a polymer. By aligning the liquid crystal material to exhibit refractive index anisotropy, the liquid crystal compound can form a retardation layer. A polymer film obtained by casting, coating, or the like is stretched or the like to exhibit refractive index anisotropy, the polymer can form a retardation layer. The retardation layer used in the present invention is preferably a layer formed of a liquid crystal compound from the viewpoint of thin thickness and more preferably a layer formed of a liquid crystal compound having a polymerizable group.

The type of the liquid crystal compound is not particularly limited. In general, the types of the liquid crystal compound can be classified into a rod-shaped type (rod-like liquid crystal compound) and a disk-shaped type (discotic liquid crystal compound) from the shapes thereof. Furthermore, the liquid crystal compound can be classified into a low-molecular-weight type and a high-molecular-weight type. The term “high-molecular-weight” generally refers to a compound having a degree of polymerization of 100 or more (Polymer Physics-Phase Transition Dynamics, written by Masao Doi, p.2, published by Iwanami Shoten, 1992). Any liquid crystal compound can be used in the present invention, and it is preferable to use a rod-like liquid crystal compound or a discotic liquid crystal compound and it is more preferable to use a rod-like liquid crystal compound. Two or more types of rod-like liquid crystal compounds, two or more types of discotic liquid crystal compounds, or a mixture of a rod-like liquid crystal compound and a discotic liquid crystal compound may be used.

Examples of the rod-like liquid crystal compound include liquid crystal compounds described in claim 1 of JP1999-513019A (JP-H11-513019A) and paragraphs 0026 to 0098 of JP2005-289980A.

Examples of the discotic liquid crystal compound include liquid crystal compounds described in paragraphs 0020 to 0067 of JP2007-108732A and paragraphs 0013 to 0108 of JP2010-244038A.

The liquid crystal compound preferably has a polymerizable group. That is, the liquid crystal compound is preferably a polymerizable liquid crystal compound. In a case where the liquid crystal compound has a polymerizable group, the alignment state of the liquid crystal compound can be easily fixed by a curing treatment described later.

The type of the polymerizable group contained in the liquid crystal compound is not particularly limited, and is preferably a functional group capable of an addition polymerization reaction, more preferably a polymerizable ethylenic unsaturated group or a ring-polymerizable group, and still more preferably a (meth)acryloyl group, a vinyl group, a styryl group, or an allyl group.

The number of polymerizable groups contained in the liquid crystal compound is not particularly limited, but is preferably 2 or more. The upper limit of the number of standard samples in the sample set is not particularly limited, and is often 10 or less.

The liquid crystal compound may be a liquid crystal compound exhibiting any of forward wavelength dispersibility or reverse wavelength dispersibility. In a case where a retardation layer exhibiting characteristics of a broadband λ/4 plate is used as a single film, a liquid crystal compound exhibiting reverse wavelength dispersibility is preferable, and a liquid crystal compound having two or more polymerizable groups and exhibiting reverse wavelength dispersibility is more preferable.

In the present specification, the “liquid crystal compound exhibiting reverse wavelength dispersibility” refers to a compound in which, in a case where an in-plane retardation (Re) value at a specific wavelength (visible light range) of an optically anisotropic layer produced using the compound is measured, the above-described relationships of Expression (A) and Expression (B) are satisfied.

In addition, in the present specification, the “liquid crystal compound exhibiting forward wavelength dispersibility” refers to a compound in which, in a case where an in-plane retardation (Re) value at a specific wavelength (visible light range) of a retardation layer produced using the compound is measured, a relationship between Expression (C) and Expression (D) is satisfied.

$$Re ( 450 ) / Re ( 550 ) \geq 1. \qquad Expression ( C )$$

$$Re ( 650 ) / Re ( 550 ) < 1. \qquad Expression ( D )$$

As described above, the retardation layer is preferably a layer formed of a liquid crystal compound having a polymerizable group, and more preferably a layer formed by fixing an alignment state of a liquid crystal compound having a polymerizable group.

The alignment state that the liquid crystal compound having a polymerizable group can take is not particularly limited, and examples thereof include a homogeneous alignment, a homeotropic alignment, a twisted alignment, a cholesteric alignment, a hybrid alignment (alignment in which a tilt angle of the liquid crystal compound continuously changes from one surface to another surface), and a tilt alignment (alignment in which a tilt angle of the liquid crystal compound is constant from one surface to another surface). The twisted alignment represents an alignment state in which the liquid crystal compound is twisted with respect to the thickness direction as a rotation axis, and in a case where the liquid crystal compound is twisted and aligned and has a predetermined tilt angle (tilt angle is more than) 0°, the twisted alignment corresponds to a twisted hybrid alignment. In the present specification, the twisted alignment corresponds to an aspect in which the twisted angle of the liquid crystal compound is less than 360°, and the cholesteric alignment corresponds to an aspect in which the twisted angle of the liquid crystal compound is 360° or more.

The “fixed” state is the most typical and preferable aspect of a state in which the alignment of the liquid crystal compound is maintained. The “fixed” state is not limited thereto and is specifically more preferably a state in which, in a temperature range of usually 0° C. to 50° C. or in a temperature range of −30° C. to 70° C. under more severe conditions, the layer has no fluidity and a fixed alignment form can be maintained stably without causing a change in the alignment form due to an external field or an external force.

The retardation layer formed of a liquid crystal compound may have a plurality of regions in which alignment states of the liquid crystal compound are different from each other along a thickness direction. For example, the retardation layer may have a region formed by fixing a state where the liquid crystal compound is homogeneously aligned and a region formed by fixing a state where the liquid crystal compound is twisted and aligned, along the thickness direction.

The thickness of the retardation layer is not particularly limited, but is preferably 0.1 to 10.0 μm and more preferably 0.5 to 5.0 μm.

Specific examples of the configuration of the broadband λ/4 plate include, as a retardation layer formed of a single-layer retardation layer, a retardation layer formed of a liquid crystal compound exhibiting reverse wavelength dispersibility, which is disclosed in WO2019/160016A, JP2020-173460A, WO2021/157694A, and the like, and a retardation layer having a plurality of regions having different alignment states of a liquid crystal compound in a thickness direction, which is disclosed in WO2022/030308A, JP2022-184691A, and the like. In addition, examples of a retardation layer having a configuration in which two or more retardation layers are laminated include a λ/4 retardation layer and a λ/2 retardation layer disclosed in JP2001-108825A, JP2001-091741A, WO2013/137464A, and the like are combined, and a configuration in which a retardation layer having a twisted alignment and another retardation layer disclosed in JP2001-021720A, JP2014-209219A, WO2022/255105A, and the like are combined. In addition, in order to compensate for a change in retardation with respect to incident light in an oblique direction, other retardation layers such as a positive C-plate and a negative C-plate may be further added.

### [Light Interference Layer]

The retardation film according to the embodiment of the present invention includes a light interference layer. The light interference layer may be configured with a single-layer light interference layer, or may be configured by laminating two or more light interference layers by a method such as bonding or sequential formation.

The film thickness of the single-layer light interference layer is preferably in a range of 60 nm to 110 nm or 230 nm to 330 nm, more preferably in a range of 75 nm to 100 nm or 245 nm to 300 nm, and most preferably in a range of 80 nm to 95 nm or 260 nm to 285 nm.

In a case where a general liquid crystal material and an adhesive layer are used, the refractive indices thereof are approximately 1.625 and approximately 1.5, respectively. Therefore, the refractive index of the light interference layer is preferably 1.50 to 1.70 and more preferably 1.53 to 1.59.

For the adhesive layer and the retardation layer having any refractive index, the preferred range of the light interference layer can be generalized using the average refractive index of the adhesive layer and the retardation layer, and it is preferable to satisfy the conditions described below. That is, in a case where the refractive index of the adhesive layer adjacent to the light interference layer is nA and the average refractive index of the retardation layer is nL, the refractive index nI of the light interference layer is preferably (nA×nL)^{1/2}−0.03≤nI≤(nA×nL)^{1/2}+0.03, more preferably (nA×nL)^{1/2}−0.02≤nI≤(nA×nL)^{1/2}+0.02, and most preferably (nA×nL)^{1/2}−0.01≤nI≤(nA×nL)^{1/2}+0.01.

It is considered that, by setting the refractive index of the light interference layer in this range, the amplitude reflectivity on both surfaces of the light interference layer can be made to be the same magnitude, and thus a large antireflection effect can be obtained. As a result, reflected light generated by the interface reflection can be suppressed. Since the reflected light of which the rotation direction is changed due to the interface reflection is one of the causes of the occurrence of the ghost, it is considered that the occurrence of the ghost can be suppressed by suppressing the interface reflection.

Each refractive index of the light interference layer, the retardation layer, and the adhesive layer can be measured with reference to the method described in Examples.

In a case of forming the light interference layer, the light interference layer may be formed on the retardation layer, or the light interference layer may be formed on the temporary support and then the retardation layer may be formed thereon. As a material for forming the light interference layer, a hardcoat material in which a monomer is crosslinked, a photo-alignment film, and a C-plate using a liquid crystal material can be used. Among these, the photo-alignment film is more preferable since the photo-alignment film also has a function of aligning liquid crystals in a case where a retardation layer is formed using a liquid crystal material on the photo-alignment film. In addition, among these, the C-plate also plays a role in optical compensation adjustment, which is more preferable. Furthermore, a positive C-plate is more preferable. Here, the positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

### [Material for Photo-Alignment Film]

As the light interference layer, a so-called photo-alignment film (photo-alignment layer) obtained by irradiating a photo-alignable material with polarized light or non-polarized light to form an alignment layer is also a preferable aspect. It is preferable to impart an alignment regulating force to the photo-alignment film by a step of radiating polarized light from a vertical direction or an oblique direction, or a step of radiating non-polarized light from an oblique direction.

By using the photo-alignment film, it is possible to horizontally align the specific liquid crystal compounds with excellent symmetry. Therefore, the retardation layer positive A-plate formed by using the photo-alignment film is particularly useful for optical compensation in a liquid crystal display device which does not require a pre-tilt angle of a drive liquid crystal, such as a liquid crystal display device in an in-place-switching (IPS) mode.

Examples of the photo-alignment material used for a photo-alignment film include the azo compounds described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B, the aromatic ester compounds described in JP2002-229039A, the maleimide and/or alkenyl-substituted nadimide compounds having photo-alignment units described in JP2002-265541A and JP2002-317013A, the photocrosslinkable silane derivatives described in JP4205195B and JP4205198B, the photocrosslinkable polyimides, polyamides, and esters described in JP2003-520878A, JP2004-529220A, and JP4162850B, and the photodimerizable compounds, in particular, a cinnamate compound, a chalcone compound, and a coumarin compound, described in JP1997-118717A (JP-H09-118717A), JP1998-506420A (JP-H10-506420A), JP2003-505561A, WO2010/150748A, JP2013-177561A, and JP2014-012823A. Particularly preferred examples of the photo-alignment material include the azo compounds, the photocrosslinkable polyimides, the polyamides, the esters, the cinnamate compounds, and the chalcone compounds.

### [Material for Interlayer Photo-Alignment Film]

The light interference layer preferably includes a material for an interlayer photo-alignment film. As a result, in a case where the liquid crystal material is applied to the light interference layer, the liquid crystal alignment can be performed, and a structure in which the light interference layer and the light reflecting layer are adjacent to each other can be formed. As the material for an interlayer photo-alignment film, a photo-alignment polymer described in JP2021-143336A can be used.

The material for an interlayer photo-alignment film is preferably a compound having a cinnamoyl group. The cinnamoyl compound is preferably contained between the light interference layer (preferably, the C-plate) and the retardation layer. That is, the cinnamoyl compound is preferably included in a region in the vicinity of a boundary between the light interference layer (preferably, the C-plate) and the retardation layer.

### [Adhesive Layer]

As the adhesive layer, a known adhesive, a pressure sensitive adhesive, or the like can be appropriately used as long as the adhesive has a refractive index satisfying the above relational expression, and for example, an adhesive and/or a pressure sensitive adhesive used in a laminated optical film described later can be appropriately used.

Any commercially available pressure sensitive adhesive can be used as a pressure sensitive adhesive for the above-described pressure sensitive adhesive layer, but from the viewpoint of thinning and viewpoint of reducing a surface roughness Ra, a thickness thereof is preferably 25 μm or less, more preferably 15 μm or less, and still more preferably 6 μm or less. In addition, a pressure sensitive adhesive which is unlikely to generate outgas is preferable as the pressure sensitive adhesive. Particularly in a case where the laminated optical film is stretched, molded, or the like, a vacuum process, a heating process, or the like may be performed, and it is preferable that no outgas is generated even under such conditions.

A commercially available adhesive or the like can be optionally used as the adhesive for the above-described adhesive layer, and for example, an epoxy resin-based adhesive and an acrylic resin-based adhesive can be used.

From the viewpoint of thinning and viewpoint of reducing the surface roughness Ra of the linear reflective polarizer used in the laminated optical film, a thickness of the adhesive is preferably 25 μm or less, more preferably 5 μm or less, and still more preferably 1 μm or less. In addition, from the viewpoint of reducing the thickness of the adhesive layer and coating an adherend with the adhesive such that the thickness thereof is uniform, a viscosity of the adhesive is preferably 300 cP or less and more preferably 100 cP or less.

In addition, in a case where the adherend has surface unevenness, from the viewpoint of reducing the surface roughness Ra of the linear reflective polarizer used in the laminated optical film, appropriate viscoelasticity or an appropriate thickness of the pressure sensitive adhesive and the adhesive can also be selected so that the surface unevenness of the layer to be bonded can be embedded. From the viewpoint of embedding the surface unevenness, it is preferable that the pressure sensitive adhesive and the adhesive have a viscosity of 50 cP or greater. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the laminated optical film, from the viewpoint of reducing reflection at the interface and suppressing the occurrence of ghosts, it is preferable that the pressure sensitive adhesive or the adhesive used for adhesion of each layer has a small difference in refractive index from the adjacent layer. Since the retardation layer has birefringence, refractive indices differ between a fast axis direction and a slow axis direction. In a case where an average refractive index nave of a liquid crystal layer is obtained by adding the refractive indices in the fast axis direction and the slow axis direction and dividing by 2, a difference between a refractive index of the adjacent pressure sensitive adhesive layer or adhesive layer and nave is preferably 0.075 or less, more preferably 0.05 or less, and still more preferably 0.025 or less. The refractive index of the pressure sensitive adhesive or the adhesive can be adjusted, for example, by mixing fine particles of titanium oxide, fine particles of zirconia, and the like.

In addition, in the adhesive layer between each layer, it is also preferable that a thickness of the adhesive layer is 100 nm or less. In a case where the thickness of the adhesive layer is 100 nm or less, light in the visible region is less likely to be affected by the difference in refractive index, and extra reflection can be suppressed. The thickness of the adhesive layer is more preferably 50 nm or less and still more preferably 30 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind, thickness, and the like of the adhesive layer can be adjusted for each of the bonding surfaces. Specifically, for example, the adhesive layer having a thickness of 100 nm or less can be provided by the procedures (1) to (3) described below.

(1) A layer to laminate is bonded to a temporary support consisting of a glass base material.

(2) A SiOx layer having a thickness of 100 nm or less is formed on both the surface of the layer to laminate and the surface of the layer to be laminated by vapor deposition or the like. The vapor deposition can be carried out by, for example, a vapor deposition device (model number ULEYES, manufactured by ULVAC, Inc.) using SiOx powder as a vapor deposition source. In addition, it is preferable that the surface of the formed SiOx layer is subjected to a plasma treatment.

(3) After the formed SiOx layers are bonded to each other, the temporary support is peeled off. It is preferable that the bonding is carried out, for example, at a temperature of 120° C.

The application, the adhesion, or the bonding of each layer may be carried out by a roll-to-roll or single-wafer method.

The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

The retardation film according to the embodiment of the present invention may include a support, an alignment layer, or the like, but the support and the alignment layer may be a temporary support which is peeled off and removed during the production of the laminated optical film described later. It is preferable that a temporary support is used from the viewpoint that the thickness of the laminated optical film can be reduced by transferring the retardation film to another laminated optical film and peeling and removing the temporary support and the adverse effect of the retardation of the temporary support on the polarization degree of transmitted light can be eliminated.

The type of the support is not particularly limited, but it is preferable that the support is transparent to visible light, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, cyclic polyolefin, polyacrylate, or polymethacrylate is preferable. In addition, commercially available cellulose acetate films (for example, “TD80U” or “Z-TAC” manufactured by FUJIFILM Corporation) can also be used.

In a case where the support is a temporary support, a support having high tear strength is preferable from the viewpoint of preventing breakage during peeling. For example, a polycarbonate-based film and a polyester-based film are preferable.

In addition, from the viewpoint of suppressing the adverse effect on the polarization degree of transmitted light, it is preferable that the support has a small retardation. Specifically, a magnitude of Re at 550 nm is preferably 10 nm or less, and an absolute value of a magnitude of Rth is preferably 50 nm or less. In addition, even in a case where the support is used as the above-described temporary support, it is preferable that the temporary support has a small retardation from the viewpoint of performing quality inspection of the retardation film and the laminated optical film in a step of manufacturing a laminated optical film, which will be described later.

In addition, it is preferable that the retardation film, which is used in the laminated optical film described below, is transparent to near-infrared light in order to minimize the influence on various sensors incorporated in optical systems such as a virtual reality display device and an electronic finder, in which near-infrared light for eye tracking, facial expression recognition, and iris recognition is used as a light source.

### [Laminated Optical Film]

It is preferable that the laminated optical film according to the embodiment of the present invention includes at least a retardation film that converts circularly polarized light into linearly polarized light and a linear reflective polarizer in this order.

As the retardation film, the above-described retardation film is used. The preferred aspect of the retardation film is as described above.

It is preferable that the linear reflective polarizer is disposed on a side of the retardation layer opposite to the light interference layer.

As a suitable use example of the laminated optical film according to the embodiment of the present invention, a virtual reality display device using the laminated optical film according to the embodiment of the present invention is exemplified, and actions of the laminated optical film according to the embodiment of the present invention will be described in detail.

FIG. 3 is a schematic diagram of the virtual reality display device formed using the laminated optical film according to the embodiment of the present invention. In the virtual reality display device of the aspect shown in FIG. 3, a laminated optical film 100 having the retardation film and the linear reflective polarizer, a half mirror 300, a circularly polarizing plate 400, and an image display panel 500 are arranged in this order from a visually recognizable side. As shown in FIG. 3, a ray 1000 emitted from the image display panel 500 is transmitted through the circularly polarizing plate 400 to be converted into circularly polarized light, and is transmitted through the half mirror 300. Next, the ray transmits through the retardation film of the laminated optical film 100 according to the embodiment of the present invention to be converted into linearly polarized light parallel to the reflection axis of the linear reflective polarizer, and then is reflected from the linear reflective polarizer. Next, the ray is reflected again from the half mirror 300 and is incident into the laminated optical film 100 again. Here, in a polarization state of the ray 1000, since the ray 1000 is reflected by the half mirror, the ray 1000 is converted into circularly polarized light having a turning direction opposite to that of the circularly polarized light in a case of incidence on the laminated optical film 100 for the first time. In a case where the light in this polarization state is transmitted through the retardation film of the laminated optical film, the light is converted into linearly polarized light parallel to the transmission axis of the linear reflective polarizer. As a result, the ray 1000 is transmitted through the laminated optical film 100 and is visually recognized by the user. In addition, in a case where the ray 1000 is reflected by the half mirror 300, since the half mirror has a concave mirror shape, an image displayed on the image display panel 500 is magnified so that the user can visually recognize the magnified virtual image. The system described above is referred to as a reciprocating optical system, a folded optical system, or the like.

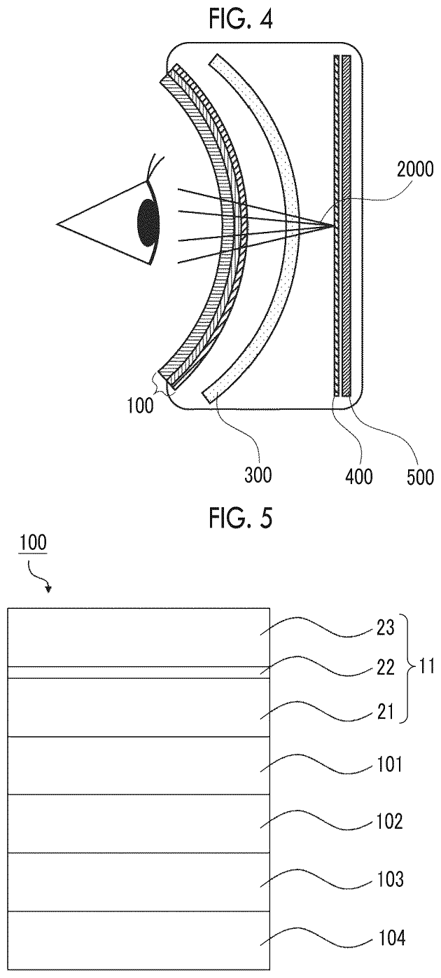

On the other hand, FIG. 4 is a schematic diagram for explaining a case where the ghost occurs in the virtual reality display device shown in FIG. 3. More specifically, FIG. 4 is a schematic diagram showing a case where a ray 2000 is transmitted without being reflected by the half mirror, so that the ray 2000 is leakage light, in a case where the ray 2000 is incident on the laminated optical film 100 for the first time in the virtual reality display device. As shown in FIG. 4, in a case where the ray 2000 is incident on the laminated optical film 100 for the first time, is transmitted without being reflected by the half mirror, and leakage light is generated, as can be seen from FIG. 4, the user visually recognizes an unenlarged image. This image is referred to as the ghost or the like, and the ghost or the like is required to be suppressed.

There are mainly two causes of the occurrence of the leakage light (ghost). One is a retardation in the reflective polarizer, and the other is the occurrence of leakage light (ghost occurrence) due to a change in rotation direction caused by the interface reflection described above with reference to FIG. 6.

Since the laminated optical film 100 according to the embodiment of the present invention has a high polarization degree, leakage of transmitted light (that is, the ghost) in a case where a ray is incident on the laminated optical film 100 for the first time can be reduced.

In addition, since the laminated optical film 100 according to the embodiment of the present invention has a high polarization degree with respect to the transmitted light, it is possible to increase the transmittance in a case where the ray is incidence on the laminated optical film 100 for the second time, and it is possible to improve brightness of the virtual image and further suppress tint of the virtual image.

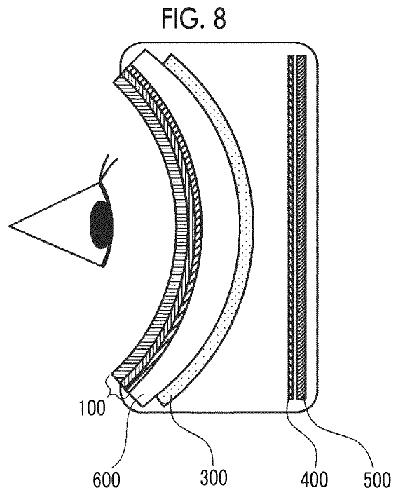

As shown in FIGS. 3 and 4, the laminated optical film 100 is preferably curved. In the configuration in which the laminated optical film 100 is curved, the laminated optical film 100 itself may be molded in a curved shape, or may be laminated on a surface of a member having a curved surface, such as the lens 600, and curved as shown in FIG. 8.

FIG. 5 shows an example of a layer configuration of the laminated optical film 100 according to the embodiment of the present invention. In the laminated optical film 100 shown in FIG. 5, the retardation film 11, the adhesive layer 101, the linear reflective polarizer 102, an adhesive layer 103, and a linear polarizer 104 are arranged in this order. As described above, the retardation film 11 includes the retardation layer 21, the light interference layer 22, and the adhesive layer 23. The linear polarizer 104 is preferably an absorptive linear polarizer.

Since the laminated optical film according to the embodiment of the present invention includes a retardation film 11 that converts circularly polarized light into linearly polarized light, the linear reflective polarizer 102, and the linear polarizer 104 in this order, the light transmitted through the linear reflective polarizer 102 can be absorbed by the linear polarizer. Therefore, the polarization degree of the transmitted light can be increased.

In addition, it is preferable that a surface roughness Ra of the laminated optical film according to the embodiment of the present invention is 100 nm or less. In a case where the Ra is small, sharpness of the image can be improved, for example, in a case where the laminated optical film is used in the virtual reality display device or the like. The present inventors have presumed that, in a case where the light is reflected on the laminated optical film, an angle of the reflected light is distorted in a case where the laminated optical film has unevenness, which leads to image distortion, blurriness, and the like. The Ra of the laminated optical film is more preferably 50 nm or less, still more preferably 30 nm or less, and particularly preferably 10 nm or less.

In addition, the laminated optical film according to the embodiment of the present invention is produced by laminating a plurality of layers. According to the studies conducted by the present inventors, it has been found that, in a case where a layer is laminated on a layer with unevenness, the unevenness may be amplified. Therefore, in the laminated optical film according to the embodiment of the present invention, it is preferable that all the layers have a small Ra. Each layer of the laminated optical film according to the embodiment of the present invention has Ra of preferably 50 nm or less, more preferably 30 nm or less, and still more preferably 10 nm or less.

In addition, from the viewpoint of increasing the image sharpness of the reflected image, it is particularly preferable that the linear reflective polarizer has a small Ra.

The surface roughness Ra can be measured by, for example, a non-contact surface/layer cross-sectional shape measuring system VertScan (manufactured by Ryoka System, Inc.). Since the Vertscan is a surface shape measurement method using a phase of reflected light from a sample, in a case of measuring a linear reflective polarizer, reflected light from inside the film may be superimposed, and thus the surface shape may not be accurately measured. In this case, a metal layer may be formed on the surface of the sample to increase the reflectivity of the surface and further suppress the reflection from the inside. As a method of forming the metal layer on the surface of the sample, for example, a sputtering method is used. Au, Al, Pt, or the like is used as a material to be sputtered.

It is preferable that the number of point defects per unit area in the laminated optical film according to the embodiment of the present invention is small. Since the laminated optical film according to the embodiment of the present invention is produced by laminating a large number of layers, it is preferable that the number of point defects in each layer is also small in order to reduce the number of point defects in the entire laminated optical film. Specifically, the number of point defects in each layer is preferably 20 or less, more preferably 10 or less, and still more preferably 1 or less per square meter. The number of point defects in the entire laminated optical film is preferably 100 or less, more preferably 50 or less, and still more preferably 5 or less per square meter.

Since the point defects lead to a decrease in polarization degree of transmitted light, a decrease in image sharpness, or the like, it is preferable that the number of point defects is small.

Here, the point defects include foreign matter, scratches, stains, fluctuations in film thickness, alignment failure of a liquid crystal compound, and the like.

In addition, it is preferable that the number of the above-described point defects is counted with the number of point defects having a size of preferably 100 μm or more, more preferably 30 μm or more, and still more preferably 10 μm or more.

In addition, various sensors may be incorporated in optical systems such as a virtual reality display device and an electronic finder, in which near-infrared light for eye tracking, facial expression recognition, and iris recognition is used as a light source, and in order to minimize the influence on the sensor, it is preferable that the laminated optical film according to the embodiment of the present invention is transparent to near-infrared light.

### [Linear Polarizer]

The linear polarizer used in the laminated optical film according to the embodiment of the present invention is preferably an absorption type linear polarizer. The absorption type linear polarizer absorbs linearly polarized light in an absorption axis direction among incidence rays, and transmits linearly polarized light in a transmission axis direction. A typical polarizer can be used as the linear polarizer, and examples thereof may include a polarizer in which a dichroic substance is dyed on polyvinyl alcohol or another polymer resin and is stretched so that the dichroic substance is aligned and a polarizer in which a dichroic substance is aligned by using alignment of a liquid crystal compound. Among these, from the viewpoint of availability and an increase in polarization degree, a polarizer obtained by dyeing polyvinyl alcohol with iodine and stretching polyvinyl alcohol is preferable.

A thickness of the linear polarizer is preferably 10 μm or less, more preferably 7 μm or less, and still more preferably 5 μm or less. In a case where the linear polarizer is thin, cracks, breakage, and the like can be prevented in a case where the laminated optical film is stretched or molded.

In addition, a single plate transmittance of the linear polarizer is preferably 40% or more and more preferably 42% or more. Moreover, the polarization degree is preferably 90% or more, more preferably 95% or more, and still more preferably 99% or more. In the present specification, the single plate transmittance and the polarization degree of the linear polarizer are measured using an automatic polarizing film measuring device: VAP-7070 (manufactured by Jasco Corporation).

In addition, it is preferable that the direction of the transmission axis of the linear polarizer coincides with the direction of the polarization axis of light converted into linearly polarized light by the retardation layer. For example, in a case where the retardation layer is a layer having a retardation of a ¼ wavelength, an angle between the transmission axis of the linear polarizer and the slow axis of the retardation layer is preferably approximately 45°.

It is also preferable that the linear polarizer used in the laminated optical film according to the embodiment of the present invention is a light absorption anisotropic layer containing a liquid crystal compound and a dichroic substance. A linear polarizer containing a liquid crystal compound and a dichroic substance is preferable from the viewpoint that the thickness thereof can be reduced and cracks, breakage, and the like are unlikely to occur even in a case where the laminated optical film is stretched, molded, or the like. A thickness of the light absorption anisotropic layer is not particularly limited, but is preferably 0.1 to 8 μm and more preferably 0.3 to 5 μm from the viewpoint of thinning.

The linear polarizer containing a liquid crystal compound and a dichroic substance can be produced with reference to, for example, JP2020-023153A. From the viewpoint of improving the polarization degree of the linear polarizer, an alignment degree of the dichroic substance in the light absorption anisotropic layer is preferably 0.95 or more and more preferably 0.97 or more.

A liquid crystal compound which does not exhibit dichroic properties in the visible region is preferable as a liquid crystal compound contained in a composition used for forming the light absorption anisotropic layer, which is used to form the light absorption anisotropic layer.

As such a liquid crystal compound, both a low-molecular-weight liquid crystal compound and a polymer liquid crystal compound can be used. Here, the “low-molecular-weight liquid crystal compound” denotes a liquid crystal compound having no repeating units in the chemical structure. In addition, the “polymer liquid crystal compound” refers to a liquid crystal compound including a repeating unit in a chemical structure.

Examples of the polymer liquid crystal compound include thermotropic liquid crystal polymers described in JP2011-237513A. In addition, it is preferable that the polymer liquid crystal compound has a crosslinkable group (such as an acryloyl group or a methacryloyl group) at a terminal.

The liquid crystal compound may be used alone or in combination of two or more kinds thereof. It is also preferable that the polymer liquid crystal compound and the low-molecular-weight liquid crystal compound are used in combination.

A content of the liquid crystal compound is preferably 25 to 2000 parts by mass, more preferably 33 to 1000 parts by mass, and still more preferably 50 to 500 parts by mass with respect to 100 parts by mass of a content of the dichroic substance in the present composition. In a case where the content of the liquid crystal compound is within the above-described range, the alignment degree of the polarizer is further improved.

The dichroic substance contained in the composition for forming the light absorption anisotropic layer, which is used to form the light absorption anisotropic layer, is not particularly limited, and examples thereof include a visible light absorbing substance (dichroic coloring agent), an ultraviolet absorbing substance, an infrared absorbing substance, a nonlinear optical substance, and a carbon nanotube. In addition, known dichroic substances (dichroic coloring agents) of the related art can be used.

In the present invention, two or more kinds of dichroic substances may be used in combination. For example, from the viewpoint of obtaining a high polarization degree over a wider wavelength range, it is preferable that at least one dichroic substance having a maximal absorption wavelength in a wavelength range of 370 to 550 nm and at least one dichroic substance having a maximal absorption wavelength in a wavelength range of 500 to 700 nm are used in combination.

In a case where the linear polarizer includes the light absorption anisotropic layer containing the liquid crystal compound and the dichroic substance, the linear polarizer may include a support, an alignment layer, or the like, but the support and the alignment layer may be a temporary support which is peeled off and removed during the production of the laminated optical film. It is preferable that a temporary support is used from the viewpoint that the thickness of the laminated optical film can be reduced by transferring the light absorption anisotropic layer to another laminate and peeling and removing the temporary support and the adverse effect of the retardation of the temporary support on the polarization degree of transmitted light can be eliminated.

The type of the support is not particularly limited, but it is preferable that the support is transparent to visible light, and for example, the same support as the support used in the above-described retardation layer can be used. Preferred aspects of the support used in the linear polarizer are the same as the preferred aspects of the support used in the above-described retardation layer.

In addition, it is preferable that the linear polarizer used in the laminated optical film according to the embodiment of the present invention is transparent to near-infrared light in order to minimize the influence on various sensors incorporated in optical systems such as a virtual reality display device, an electronic finder, and the like, in which near-infrared light for eye tracking, facial expression recognition, and iris recognition is used as a light source.

### [Other Functional Layers]

The laminated optical film according to the embodiment of the present invention may include other functional layers in addition to the retardation film, the linear reflective polarizer, and the linear polarizer.

In addition, it is preferable that the other functional layers are transparent to near-infrared light in order to minimize the influence on various sensors incorporated in optical systems such as a virtual reality display device and an electronic finder, in which near-infrared light for eye tracking, facial expression recognition, and iris recognition is used as a light source.

### <Positive C-Plate>

It is also preferable that the laminated optical film according to the embodiment of the present invention further includes a positive C-plate. Here, the positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

The positive C-plate functions as an optical compensation layer for increasing the polarization degree of the transmitted light with respect to light incident obliquely. The positive C-plates can be provided at any position of the laminated optical film, and a plurality of the positive C-plates may be provided.

The positive C-plate may be installed adjacent to the retardation film or inside the retardation film. For example, in a case where a layer formed by immobilizing a rod-like liquid crystal compound is used as the retardation film, the retardation layer has a positive Rth. Here, in a case where light is incident on the retardation layer in an oblique direction, the polarization state of the transmitted light may change due to the action of the Rth, and the polarization degree of the transmitted light may decrease. In a case where the positive C-plate is provided inside or in the vicinity of the retardation layer, the change in polarization state of the oblique incident light can be further suppressed, so that the decrease in polarization degree of the transmitted light can be further suppressed, and as a result, the ghost can be further suppressed, which is preferable. According to the study by the present inventors, the positive C-plate is preferably disposed between the lens and the retardation film, but may be disposed between the retardation film and the linear reflective polarizer or may be installed at other places. In this case, Re(550) of the positive C-plate is preferably approximately 10 nm or less, and Rth(550) is preferably −90 to −40 nm.

### <Antireflection Layer>

It is also preferable that the laminated optical film according to the embodiment of the present invention includes an antireflection layer on a surface thereof. The laminated optical film according to the embodiment of the present invention has a function of reflecting specific circularly polarized light and transmitting circularly polarized light orthogonal to the specific circularly polarized light, and the reflection on a surface of the laminated optical film typically includes unintended reflection of polarized light, which may lead to the decrease in polarization degree of the transmitted light. Therefore, it is preferable that the laminated optical film includes an antireflection layer on the surface thereof. The antireflection layer may be provided only on one surface or on both surfaces of the laminated optical film.

The type of the antireflection layer is not particularly limited, but from the viewpoint of further decreasing the reflectivity, a moth-eye film or an anti-reflective (AR) film is preferable. As the moth-eye film and the AR film, known films can be used.

In addition, in a case where the laminated optical film is stretched or molded, the moth-eye film is preferable from the viewpoint that high antireflection performance can be maintained even in a case of fluctuation in the film thickness due to the stretching. Furthermore, in a case where the antireflection layer includes a support and stretching, molding, and the like are performed, from the viewpoint of facilitating the stretching, the molding, and the like, a peak temperature of the glass transition temperature Tg of the above-described support is preferably 170° C. or lower and further preferably 130° C. or lower. Specifically, for example, a PMMA film or the like is preferable.

### <Second Retardation Layer>

It is also preferable that the laminated optical film according to the embodiment of the present invention further includes a second retardation layer. For example, the laminated optical film may include the retardation film, the linear reflective polarizer, the linear polarizer, and the second retardation layer in this order.

It is preferable that the second retardation layer converts linearly polarized light into circularly polarized light, and for example, a retardation layer having Re of a ¼ wavelength is preferable. The reason for this will be described below.

Light incident into the laminated optical film from the side of the retardation film and transmitted through the linear reflective polarizer and the linear polarizer is linearly polarized light, and a part of the light is reflected from the outermost surface of the linear polarizer side and emitted from the surface of the retardation film side again. Such light is extra reflected light and may decrease the polarization degree of the reflected light, and thus it is preferable that the amount of such light is reduced. Therefore, a method of laminating an antireflection layer may be considered to suppress reflection on the outermost surface on the side of the linear polarizer, but in a case where the laminated optical film is used by being bonded to a medium such as glass or plastic, the antireflection effect is hardly obtained because reflection on the surface of the medium cannot be suppressed even in a case where the antireflection layer is provided on the bonding surface of the laminated optical film.

Meanwhile, in a case where the second retardation layer which converts linearly polarized light into circularly polarized light is provided, light which reaches the outermost surface on the side of the linear polarizer is converted into circularly polarized light, and converted into circularly polarized light orthogonal to each other in a case of reflection on the outermost surface of the medium. Thereafter, in a case where the light is transmitted through the second retardation layer again and reaches the linear polarizer, the light is converted into linearly polarized light in the absorption axis azimuth of the linear polarizer and absorbed by the linear polarizer. Therefore, it is possible to prevent extra reflection.

From the viewpoint of more effectively suppressing the extra reflection, it is preferable that the second retardation layer has substantially reverse dispersibility.

### <Support>

The laminated optical film according to the embodiment of the present invention may further include a support (resin base material). The support can be provided at any position, and for example, in a case where the retardation film, the linear reflective polarizer, or the linear polarizer is a film used by being transferred from the temporary support, the support can be used as a transfer destination thereof.

The type of the support is not particularly limited, but it is preferable that the support is transparent to visible light, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, cyclic polyolefin, polyacrylate, or polymethacrylate is preferable. In addition, commercially available cellulose acetate films (for example, “TD80U” and “Z-TAC” manufactured by FUJIFILM Corporation) can also be used.

In addition, it is preferable that the support has a small retardation from the viewpoint of suppressing the adverse effect on the polarization degree of the transmitted light and viewpoint of facilitating the optical inspection of the laminated optical film. Specifically, a magnitude of Re is preferably 10 nm or less, and an absolute value of a magnitude of Rth is preferably 50 nm or less.

In a case where the laminated optical film according to the embodiment of the present invention is stretched, molded, and subjected to similar processes, the support (resin base material) preferably has a peak temperature of a loss tangent tan δ of 170° C. or lower. From the viewpoint that the laminated optical film can be molded at a low temperature, the tan δ peak temperature is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% RH for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measurement temperature:−150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) base material (TG40 manufactured by FUJIFILM Corporation), the peak temperature of tan δ is 180° C. or higher.

The support having a tan δ peak temperature of 170° C. or lower is not particularly limited, and various resin base materials can be used. Examples thereof include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available from the market and having excellent transparency, a cyclic olefin-based resin, polyethylene terephthalate, or an acrylic resin is preferable, and a cyclic olefin-based resin or polymethacrylic acid ester is particularly preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

In addition, the laminated optical film may include a layer other than the above-described layers. Examples of the layer other than the above-described layers include a pressure sensitive adhesive layer formed from a pressure sensitive adhesive described later, an adhesive layer formed from an adhesive described later, and a refractive index adjusting layer.

In addition, a refractive index adjusting layer in which a difference in refractive index between a fast axis direction and a slow axis direction is smaller than that of the retardation layer may be provided between the retardation layer and the pressure sensitive adhesive or between the retardation layer or the adhesive. In this case, the refractive index adjusting layer preferably has a layer obtained by fixing an alignment state of cholesteric liquid crystals. By providing the refractive index adjusting layer, interface reflection can be further suppressed, and occurrence of the ghost can be further suppressed. In addition, it is more preferable that an average refractive index of the refractive index adjusting layer is smaller than the average refractive index of the retardation layer.

### [Method of Bonding Each Layer]

The laminated optical film according to the embodiment of the present invention is a laminate consisting of a plurality of layers. Each layer can be bonded by an optional adhesion method, and for example, a pressure sensitive adhesive and an adhesive can be used.

Any commercially available pressure sensitive adhesive can be used as the pressure sensitive adhesive, but from the viewpoint of thinning and viewpoint of reducing a surface roughness Ra of the laminated optical film, a thickness thereof is preferably 25 μm or less, more preferably 15 μm or less, and still more preferably 6 μm or less. In addition, a pressure sensitive adhesive which is unlikely to generate outgas is preferable as the pressure sensitive adhesive. Particularly in a case where the laminated optical film is stretched, molded, or the like, a vacuum process, a heating process, or the like may be performed, and it is preferable that no outgas is generated even under such conditions.

A commercially available adhesive or the like can be optionally used as the adhesive, and for example, an epoxy resin-based adhesive and an acrylic resin-based adhesive can be used.

From the viewpoint of thinning and viewpoint of reducing the surface roughness Ra of the laminated optical film, a thickness of the adhesive is preferably 25 μm or less, more preferably 5 μm or less, and still more preferably 1 μm or less. In addition, from the viewpoint of reducing the thickness of the adhesive layer and coating an adherend with the adhesive such that the thickness thereof is uniform, a viscosity of the adhesive is preferably 300 cP or less, more preferably 100 cP or less, and still more preferably 10 cP or less.

In addition, in a case where the adherend has surface unevenness, from the viewpoint of reducing the surface roughness Ra of the laminated optical film, appropriate viscoelasticity or an appropriate thickness of the pressure sensitive adhesive, the adhesive, and the like can also be selected so that the surface unevenness of the layer to be bonded can be embedded. From the viewpoint of embedding the surface unevenness, it is preferable that the pressure sensitive adhesive, the adhesive, and the like have a viscosity of 50 cP or greater. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the laminated optical film, from the viewpoint of reducing the extra reflection and suppressing a decrease in polarization degrees of transmitted light and reflected light, it is preferable that the pressure sensitive adhesive or adhesive used for adhering each layer has a small difference in refractive index with adjacent layers. Specifically, the difference in refractive index with the adjacent layer is preferably 0.1 or less, more preferably 0.05 or less, and still more preferably 0.01 or less. The refractive index of the pressure sensitive adhesive or the adhesive can be adjusted, for example, by mixing fine particles of titanium oxide, fine particles of zirconia, and the like.

In addition, the retardation layer, the linear reflective polarizer, and the linear polarizer may have in-plane refractive index anisotropy, but the difference in refractive index with the adjacent layer is preferably 0.05 or less in all in-plane directions. Therefore, the pressure sensitive adhesive or the adhesive may have in-plane refractive index anisotropy.

In addition, in the adhesive layer between each layer, it is also preferable that a thickness of the adhesive layer is 100 nm or less. In a case where the thickness of the adhesive layer is 100 nm or less, light in the visible region is less likely to be affected by the difference in refractive index, and the reflection at the interface can be suppressed. The thickness of the adhesive layer is more preferably 50 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces. Specifically, for example, the adhesive layer having a thickness of 100 nm or less can be provided by the procedures (1) to (3) described below.

(1) A layer to laminate is bonded to a temporary support consisting of a glass base material

(2) A SiOx layer having a thickness of 100 nm or less is formed on both the surface of the layer to laminate and the surface of the layer to be laminated by vapor deposition or the like. The vapor deposition can be carried out by, for example, a vapor deposition device (model number ULEYES, manufactured by ULVAC, Inc.) using SiOx powder as a vapor deposition source. In addition, it is preferable that the surface of the formed SiOx layer is subjected to a plasma treatment.

(3) After the formed SiOx layers are bonded to each other, the temporary support is peeled off. It is preferable that the bonding is carried out, for example, at a temperature of 120° C.

The application, the adhesion, or the bonding of each layer may be carried out by roll-to-roll or single-wafer. The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

### [Direct Application of Each Layer]

It is also preferable that no adhesive layer is provided between each layer of the laminated optical film according to the embodiment of the present invention. In a case of forming a layer, the adhesive layer can be eliminated by directly coating an adjacent layer which has already been formed. Furthermore, in a case where one or both adjacent layers are layers containing a liquid crystal compound, it is preferable that the alignment direction of the liquid crystal compound is continuously changed at the interface in order to reduce the difference in refractive index in all in-plane directions. For example, the linear polarizer containing a liquid crystal compound and a dichroic substance is directly coated with a retardation layer containing a liquid crystal compound, and the liquid crystal compound of the retardation layer can be aligned to be continuous at the interface by alignment regulating force of the liquid crystal compound of the linear polarizer.

### [Lamination Order of Each Layer]

The laminated optical film according to the embodiment of the present invention consists of a plurality of layers, and the order of the steps of laminating the plurality of layers is not particularly limited and can be optionally selected.

For example, in a case where a functional layer is transferred from a film consisting of a temporary support and a functional layer, wrinkles, cracks, and the like during the transfer can be prevented by adjusting the laminating order such that the thickness of the film at the transfer destination reaches 10 μm or more.

In addition, from the viewpoint of reducing the surface roughness Ra of the laminated optical film, in a case where another layer is laminated on a layer having large surface unevenness, the surface unevenness may be further amplified, and thus it is preferable that the layers are laminated in order from a layer having a smaller surface roughness Ra.

In addition, from the viewpoint of improving the production yield of the laminated optical film and reducing the cost, it is also possible to select the laminating order.

### [Applications of Laminated Optical Film According to Embodiment of Present Invention]

For example, as disclosed in JP2017-227720A and JP2003-504663A, the laminated optical film according to the embodiment of the present invention can be used as a reflective polarizer to be incorporated in an in-vehicle room mirror, a virtual reality display device, an electronic finder, and the like. Particularly in a virtual reality display device, an electronic finder, or the like that has a reciprocating optical system allowing light to be reflected between the reflective polarizer and the half mirror to reciprocate the light, the laminated optical film according to the embodiment of the present invention is extremely useful from the viewpoint of improving the sharpness of a display image. In addition, since a virtual reality display device, an electronic finder, or the like that has a reciprocating optical system includes an optical film such as an absorption type polarizer or a circular polarizer in addition to the reflective polarizer in some cases, the sharpness of a display image can be further improved by applying the members used for the laminated optical film according to the embodiment of the present invention to the optical film other than the reflective polarizer described above.

### <Optical Article>

One form of the optical article according to the embodiment of the present invention includes a composite lens consisting of a lens and the laminated optical film according to the embodiment of the present invention. A half mirror may be formed on one surface of the lens. As the lens, a convex lens or a concave lens can be used. As the convex lens, a biconvex lens, a plano-convex lens, or a convex meniscus lens can be used. As the concave lens, a biconcave lens, a plano-concave lens, or a concave meniscus lens can be used. As the lens used in the virtual reality display device, a convex meniscus lens and a concave meniscus lens are preferable for enlarging the angle of view, and a concave meniscus lens is more preferable in that chromatic aberration can be further suppressed. As a material of the lens, glass, crystal, plastic, or the like, which is transparent to visible light, can be used. Since the birefringence of the lens causes rainbow-like unevenness or light leakage, it is preferable that the birefringence is small, and a material having zero birefringence is more preferable. The laminated optical film according to the embodiment of the present invention used in the optical article according to the embodiment of the present invention may be a flat surface or a curved surface, but a curved surface is preferable from the viewpoint that distortion or aberration of an image is small.

### <Virtual Reality Display Device>

One form of a virtual reality display device includes at least an image display device that emits polarized light and a composite lens that is the optical article according to the embodiment of the present invention. In addition, the virtual reality display device may include an additional optical member such as a half mirror and a visual acuity adjustment lens.

### <Image Display Device>

As the image display device used in the present invention, a known image display device can be used. Examples thereof include a display device in which self-luminous microscopic light emitters are arranged on a transparent substrate, such as an organic electroluminescent display device, a light emitting diode (LED) display device, and a micro LED display device. In these self-luminous display devices, a (circular) polarizing plate is usually bonded to a display surface to prevent reflection on the display surface. Therefore, the emitted light is polarized. In addition, a liquid crystal display device is exemplified as other image display devices. Since the liquid crystal display device also has a polarizing plate on the surface, the emitted light is polarized. In the following description, the organic electroluminescent display device will also be referred to as “OLED”. OLED is an abbreviation for “Organic Light Emitting Diode”.

### <Molding Method>

The laminated optical film according to the embodiment of the present invention may be used in a form of a flat surface or may be molded into a form of any shape and used. Here, the laminated optical film will be referred to as an optical film, and a molding method will be described. The method for molding an optical film includes a step of heating the optical film, a step of pressing the optical film against a mold and deforming the optical film along a shape of the mold, and a step of cutting the optical film.

### [Step of Heating Optical Film]

As a method of heating the optical film, heating by bringing a heated solid into contact, heating by bringing a heated liquid into contact, heating by bringing a heated gas into contact, heating by irradiating with infrared rays, heating by irradiating with microwaves, and the like can be used. However, the heating by irradiating with infrared rays is preferable because the optical film can be heated remotely immediately before the molding.

A wavelength of the infrared ray used for heating is preferably 1.0 μm to 30.0 μm, and more preferably used from 1.5 μm to 5 μm. As the IR light source, a near-infrared lamp heater in which a tungsten filament is inserted into a quartz tube, a wavelength control heater in which a mechanism for cooling a part between quartz tubes with air is provided by multiplexing the quartz tubes, and the like can be used. In addition, by distributing the irradiation amount of infrared rays on the optical film, physical property values during the molding can be controlled according to the purpose. As a method of providing intensity distribution, a method of varying the density of the arrangement of the IR light sources, or a method of placing a filter with a patterned transmittance to infrared light between the IR light sources and the optical film are used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, and the like is used. A temperature of the optical film is controlled by the intensity of the infrared irradiation, and by the infrared irradiation time or the illuminance of the infrared irradiation. The temperature of the optical film can be monitored using a noncontact radiation thermometer, a thermocouple, or the like, and the optical film can be molded at a target temperature.

### [Step of Pressing Optical Film Against Mold to Deform Optical Film Along Shape of Mold]

As a method of pressing the optical film against the mold and deforming the optical film along the shape of the mold, decompression and pressurization of the molding space are used. In addition, a method of pushing the mold can also be used.

### [Step of Cutting Optical Film]

As a method of cutting the molded optical film into any desired shape, a cutter, scissors, a cutting plotter, or a laser cutting machine can be used.

### <Molding Device>

In one aspect of the molding device, a box 1 having an opening portion in an upper direction and a box 2 having an opening portion in a lower direction are provided, in order to form a molding space, the opening portion of the box 1 and the opening portion of the box 2 are fitted together directly or through other holding devices to form a sealed molding space. A mold (also referred to as an adherend) having a molded shape and the film to be molded are arranged in the molding space. The film to be molded is used as a partition to divide the molding space which consists of the box 1 and the box 2 into two spaces. The mold is disposed on the box 1 side below the film to be molded. Furthermore, a vacuum molding device includes multiple heating elements arranged in a dispersed manner to heat the film to be molded. The heating element may be disposed within the molding space, or may be disposed outside the molding space to heat the film to be molded by irradiation through a transparent window.

### Examples

Hereinafter, the features of the present invention will be described in more detail with reference to Examples. The materials, the used amounts, the ratios, the treatment contents, the treatment procedures, and the like described in Examples can be appropriately changed without departing from the gist of the present invention. In addition, configurations other than the configurations described below can be employed without departing from the gist of the present invention.

### [Preparation of Coating Liquid R-1 for Retardation Layer]

A composition shown below was stirred and dissolved in a container held at 70° C. to prepare a coating liquid R-1 for a retardation layer.

Coating liquid R-1 for retardation layer

| | | |
|---|---|---|
| Methyl ethyl ketone | 120.9 | parts by mass |
| Cyclohexanone | 21.3 | parts by mass |
| Mixture A of rod-like liquid crystal compounds shown below | 100.0 | parts by mass |
| Photopolymerization initiator B shown below | 1.00 | part by mass |
| Surfactant F1 shown below | 0.1 | parts by mass |

Mixture A of rod-like liquid crystal compounds

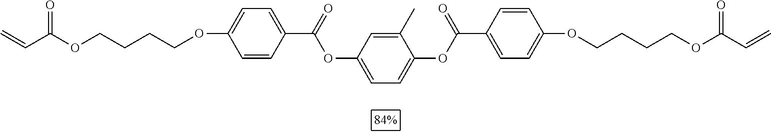 [SMILES: C=CC(=O)OCCCCOc1ccc(C(=O)Oc2ccc(OC(=O)c3ccc(OCCCCOC(=O)C=C)cc3)c(C)c2)cc1]

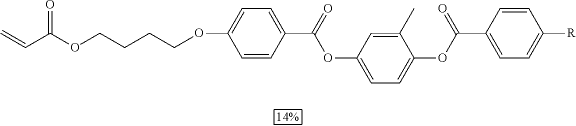

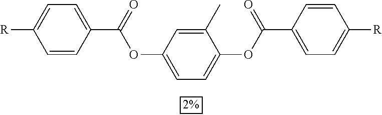

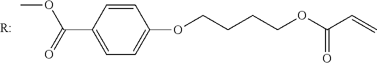

In the above-described mixture, each numerical value denotes the content in units of % by mass. In addition, R represents a group bonded via an oxygen atom. Furthermore, an average molar absorption coefficient of the above-described rod-like liquid crystal compound at a wavelength of 300 to 400 nm was 140/mol·cm.

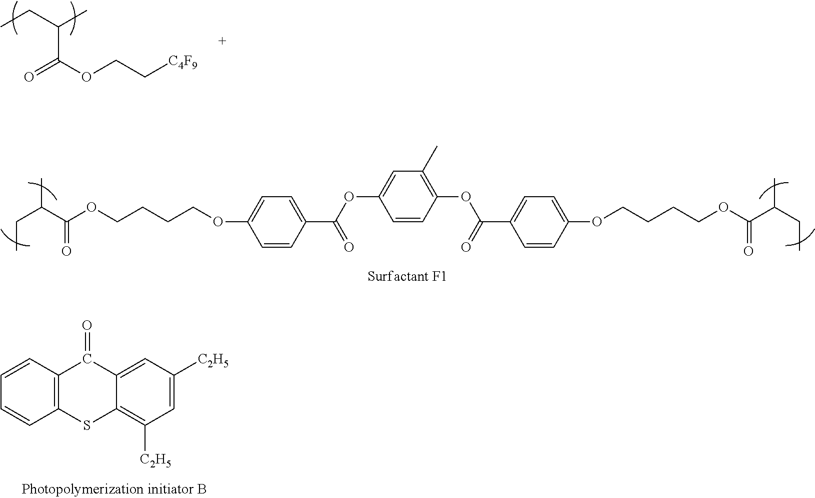

### [Preparation of Coating Liquid R-2 for Retardation Layer]

The following composition was stirred and dissolved in a container kept at 70° C. to prepare a coating liquid R-2 for a retardation layer having reverse wavelength dispersibility.

Coating liquid R-2 for retardation layer

| | | |
|---|---|---|
| Polymerizable liquid crystal compound X-1 shown below | 16.00 | parts by mass |
| Specific liquid crystal compound L-1 shown below | 42.00 | parts by mass |
| Specific liquid crystal compound L-2 shown below | 42.00 | parts by mass |
| Polymerization initiator S-1 shown below | 0.50 | parts by mass |
| Acid anhydride K-1 shown below | 4.00 | parts by mass |
| Polymerizable compound B-1 shown below | 2.00 | parts by mass |
| Leveling agent (the following compound T-1) | 0.20 | parts by mass |
| Methyl ethyl ketone (solvent) | 230.00 | parts by mass |
| Cyclopentanone (solvent) | 70.00 | parts by mass |

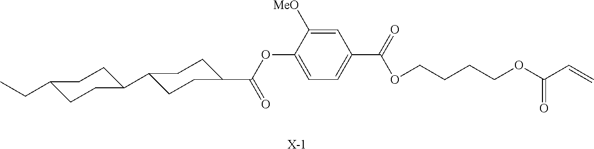 [SMILES: C=CC(=O)OCCCCOC(=O)c1ccc(OC(=O)C2CCC(C3CCC(CC)CC3)CC2)c(OC)c1 ; "X-1"]

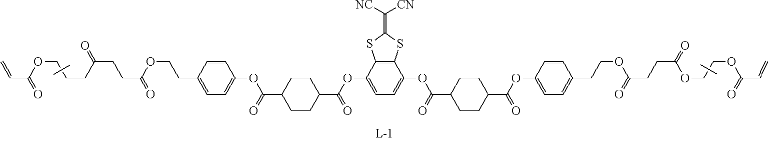

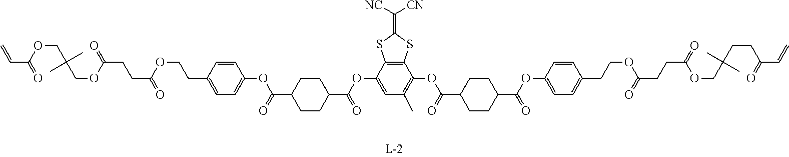 [SMILES: C=CC(=O)CCC(C)(C)COC(=O)CCC(=O)OCCc1ccc(OC(=O)C2CCC(C(=O)Oc3c(C)cc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

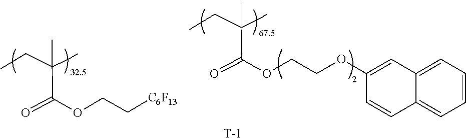

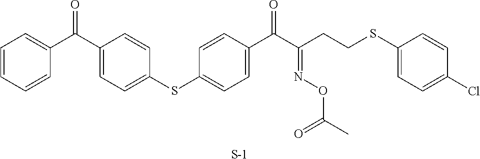

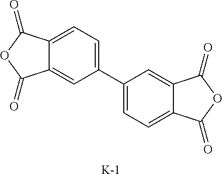

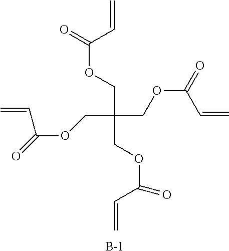

### <Coating Liquid PA-1 for Light Interference Layer>

A composition shown below was stirred and dissolved in a container held at 60° C. to prepare a coating liquid PA-1 for a light interference layer.

Coating liquid PA-1 for light interference layer

| | | |
|---|---|---|
| Methyl isobutyl ketone | 3011.0 | parts by mass |
| Mixture A of rod-like liquid crystal compounds shown above | 100.0 | parts by mass |
| Photopolymerization initiator C shown below | 5.1 | parts by mass |
| Photoacid generator shown below | 3.0 | parts by mass |
| Hydrophilic polymer shown below | 2.0 | parts by mass |
| Vertical alignment agent shown below | 1.9 | parts by mass |
| Viscosity reducing agent shown below | 4.2 | parts by mass |
| Material for interlayer photo-alignment film shown below | 8.0 | parts by mass |
| Stabilizer shown below | 0.2 | parts by mass |

Photopolymerization initiator C 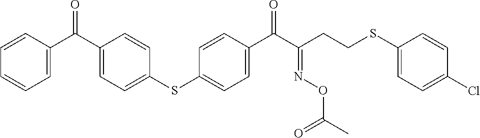 [SMILES: CC(=O)O/N=C(\CCSc1ccc(Cl)cc1)C(=O)c1ccc(Sc2ccc(C(=O)c3ccccc3)cc2)cc1]
Photoacid generator 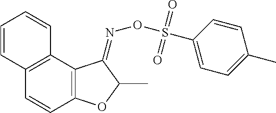 [SMILES: Cc1ccc(S(=O)(=O)O/N=C2/c3c(ccc4ccccc34)OC2C)cc1]
Hydrophilic polymer 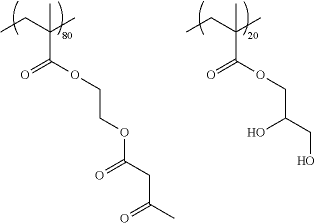
Vertical alignment agent 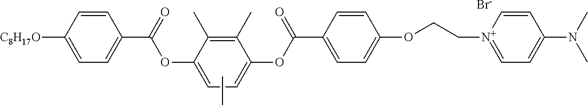
Viscosity reducing agent 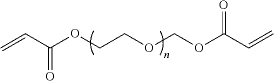
(ave = n8)
Material for interlayer photo-alignment film 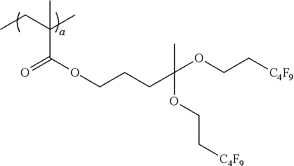 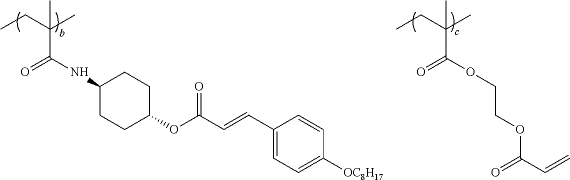
Stabilizer

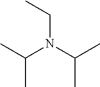

### [Manufacture of Retardation Film 1]

As a temporary support, a triacetyl cellulose (TAC) film (manufactured by FUJIFILM Corporation, TG60) having a thickness of 60 μm was prepared.

The TAC film shown above was coated with the coating liquid PA-1 for a light interference layer prepared above using a wire bar coater, and then dried at 80° C. for 60 seconds. Thereafter, the liquid crystal compound was cured by irradiating the liquid crystal compound with light from an ultraviolet LED lamp (wavelength: 365 nm) with an irradiation amount of 300 mJ/cm² at 78° C. in a low oxygen atmosphere (100 ppm), and at the same time, a cleavage site of the material for an interlayer photo-alignment film was cleaved. Thereafter, the liquid crystal compound was heated at 115° C. for 25 seconds to eliminate a substituent containing a fluorine atom. As a result, a light interference layer having a function of a positive C-plate having a cinnamoyl group on the outermost surface and a film thickness of 90 nm was formed. The refractive index nI at a wavelength of 550 nm measured with an interference film thickness meter OPTM (manufactured by Otsuka Electronics Co., Ltd., analyzed by least squares method) was 1.57. Rth at a wavelength of 550 nm, which was measured with Axoscan (manufactured by Axometrics), was-9 nm.

Next, polarized UV light (wavelength: 313 nm) with an illuminance of 7 mW/cm² and an irradiation amount of 7.9 mJ/cm² was emitted from the positive C-plate side. The polarized UV light having a wavelength of 313 nm was obtained by transmitting ultraviolet light emitted from a mercury lamp through a band-pass filter having a transmission band at a wavelength of 313 nm and a wire grid polarizing plate. The coating liquid R-1 for a retardation layer prepared above was applied onto the light interference layer with a wire bar coater and dried at 110° C. for 72 seconds. Thereafter, the surface was cured by being irradiated with light from a metal halide lamp at 100° C., an illuminance of 80 mW/cm², and an irradiation amount of 500 mJ/cm² in a low oxygen atmosphere (100 ppm or less). As a result, a retardation film consisting of a light interference layer and a retardation layer was obtained. In this case, the coating thickness was adjusted such that the film thickness of the cured retardation layer was 0.86 μm. The retardation of an obtained retardation film 1 at a wavelength of 550 nm was Re=146 nm and Rth=73 nm. AxoScan OPMF-1 (manufactured by Opto Science, Inc.) was used for the evaluation of the retardation.

### [Production of Retardation Films 2 to 6 and 8 to 16]

The retardation films 2 to 5 and 8 to 16 were produced by the same production method as that of the retardation film 1, except that the film thickness of the light interference layer was changed as shown in Table 1 below. In addition, a retardation film 6 was produced by producing a retardation layer on a rubbed PET film (A4265 manufactured by Toyobo Co., Ltd., film thickness: 100 μm) under the same conditions as that of the retardation film 1 without providing a light interference layer, thereby producing a retardation film without a light interference layer.

### [Manufacture of Retardation Film 7]

A coating liquid 1 for a photo-alignment film was prepared with reference to the description of Example 3 in JP2012-155308A, and a triacetyl cellulose (TAC) film (TG60, manufactured by FUJIFILM Corporation) having a thickness of 60 μm was applied using a wire bar. Drying with hot air was performed at 115° C. for 60 seconds to form a light interference layer having a function of a photo-alignment film, which has a cinnamoyl group on the outermost surface and has a film thickness of 90 nm. The refractive index nI at a wavelength of 550 nm measured with an interference film thickness meter OPTM (manufactured by Otsuka Electronics Co., Ltd., analyzed by least squares method) was 1.55. Rth at a wavelength of 550 nm, which was measured with Axoscan (manufactured by Axometrics), was 0 nm.

Next, polarized UV light (wavelength: 313 nm) with an illuminance of 7 mW/cm² and an irradiation amount of 7.9 mJ/cm² was emitted from the light interference layer side. The polarized UV light having a wavelength of 313 nm was obtained by transmitting ultraviolet light emitted from a mercury lamp through a band-pass filter having a transmission band at a wavelength of 313 nm and a wire grid polarizing plate. The coating liquid R-2 for a retardation layer prepared above was applied onto the light interference layer with a wire bar coater and dried at 110° C. for 72 seconds. Thereafter, the surface was cured by being irradiated with light from a metal halide lamp at 100° C., an illuminance of 80 mW/cm², and an irradiation amount of 500 mJ/cm² in a low oxygen atmosphere (100 ppm or less). As a result, a retardation film having a light interference layer and a retardation layer having reverse wavelength dispersibility was obtained. In this case, the coating thickness was adjusted such that the film thickness of the cured retardation layer was 2.5 μm. The retardation of an obtained retardation film 7 at a wavelength of 550 nm was Re=146 nm and Rth=73 nm. AxoScan OPMF-1 (manufactured by Opto Science, Inc.) was used for the evaluation of the retardation.

### [Manufacture of Retardation Film 17]

A retardation film 17 was produced by the same production method as that of the retardation film 1, except that a photo-alignment layer was formed as a light interference layer by the following process and the coating liquid for a retardation layer was changed to R-2.

### <Formation of Photo-Alignment Layer>

A coating liquid PA2 for forming an alignment layer, which will be described later, was continuously applied onto a triacetyl cellulose (TAC) film (manufactured by FUJIFILM Corporation, TG60) having a thickness of 60 μm using a wire bar. The support on which the coating film was formed was dried with hot air at 140° C. for 120 seconds, and subsequently, the coating film was irradiated with polarized ultraviolet rays (10 mJ/cm², using an ultra-high-pressure mercury lamp) to form a photo-alignment layer. The film thickness was 90 nm. The refractive index nI at a wavelength of 550 nm measured with an interference film thickness meter OPTM (manufactured by Otsuka Electronics Co., Ltd., analyzed by least squares method) was 1.55. Rth at a wavelength of 550 nm, which was measured with Axoscan (manufactured by Axometrics), was 0 nm.

(Coating liquid PA2 for forming alignment layer)

| | | |
|---|---|---|
| Polymer M-PA-1 shown below | 100.00 | parts by mass |
| Acid generator PAG-1 shown below | 5.00 | parts by mass |
| Acid generator CPI-110TF shown below | 0.005 | parts by mass |
| Xylene | 3660.00 | parts by mass |
| Methyl isobutyl ketone | 366.00 | parts by mass |

Polymer M-PA-1 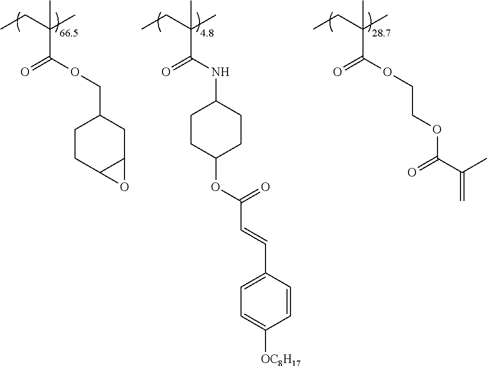
Acid generator PAG-1 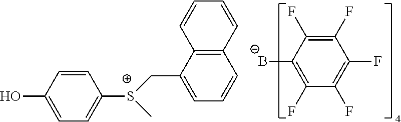
Acid generator CPI-110TF

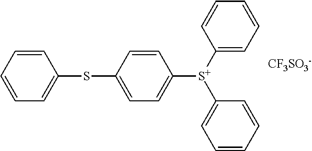

### [Manufacture of Retardation Film 18]

A retardation film 18 was produced by the same production method as that of the retardation film 17, except that the retardation of the retardation layer was changed as shown in Table 1 below.

### [Manufacture of Retardation Film 19]

A hardcoat layer having a refractive index of 1.56 and a film thickness of 90 nm was applied onto the retardation layer of the retardation film 6 to form a light interference layer. The composition of the hardcoat layer coating liquid and the coating process will be described below.

(Coating liquid HC-1 for hardcoat layer)

| | | |
|---|---|---|
| Polymerizable compound 1 | 14 | parts by mass |
| (10-functional urethane acrylate (UV-1700B | | |
| manufactured by Nippon Gohsei Chemical | | |
| Co., Ltd.)) | | |
| Polymerizable compound 2 | 6 | parts by mass |
| (Fluorene compound (Ogsol EA0200, | | |
| manufactured by Osaka Gas Chemicals | | |
| Co., Ltd.)) | | |
| Photopolymerization initiator | 0.5 | parts by mass |
| (Oxime ester-based (IRGACURE OXE01, | | |
| manufactured by BASF Japan Ltd.) | | |
| Methyl ethyl ketone | 800.00 | parts by mass |

The retardation layer of the above-described retardation film 6 was coated with the coating liquid HC-1 for a hardcoat layer, which had been adjusted as described above, using a wire bar coater, and then dried at 80° C. for 60 seconds. Thereafter, the polymerizable compound was cured by irradiation with light from an ultraviolet LED lamp (wavelength: 365 nm) at 78° C. and an irradiation amount of 300 mJ/cm² in a low oxygen atmosphere (100 ppm). In this manner, a retardation film 19 having a light interference layer with film thickness of 90 nm and consisting of a hardcoat material on the outermost surface was produced. The refractive index nI at a wavelength of 550 nm measured with an interference film thickness meter OPTM (manufactured by Otsuka Electronics Co., Ltd., analyzed by least squares method) was 1.56. Rth at a wavelength of 550 nm, which was measured with Axoscan (manufactured by Axometrics), was 0 nm.

The characteristics of the produced retardation films 1 to 19 are shown in Table 1 below. In Table 1, the retardation Re is a retardation Re as a retardation film, the refractive index is a refractive index of the light interference layer, and Rth is Rth of the light interference layer.

Table 1. Prepared retardation films 1 to 19

TABLE 1

| | | Thickness | | |
|---|---|---|---|---|
| | | of light | | |
| | | interference | | |
| | Retardation Re | layer | Refractive | |
| Retardation film | (nm) | (nm) | index | Rth(nm) |
| Retardation film 1 | 146 | 90 | 1.57 | −9 |
| Retardation film 2 | 146 | 80 | 1.57 | −8 |
| Retardation film 3 | 146 | 100 | 1.57 | −10 |
| Retardation film 4 | 146 | 270 | 1.57 | −27 |
| Retardation film 5 | 146 | 180 | 1.57 | −18 |
| Retardation film 6 | 146 | None | — | — |
| Retardation film 7 | 146 | 90 | 1.55 | 0 |
| Retardation film 8 | 146 | 50 | 1.57 | −5 |
| Retardation film 9 | 146 | 60 | 1.57 | −6 |
| Retardation film 10 | 146 | 70 | 1.57 | −7 |
| Retardation film 11 | 146 | 110 | 1.57 | −11 |
| Retardation film 12 | 146 | 120 | 1.57 | −12 |
| Retardation film 13 | 146 | 210 | 1.57 | −21 |
| Retardation film 14 | 146 | 230 | 1.57 | −23 |
| Retardation film 15 | 146 | 330 | 1.57 | −33 |
| Retardation film 16 | 146 | 350 | 1.57 | −35 |
| Retardation film 17 | 146 | 90 | 1.55 | 0 |
| Retardation film 18 | 292 | 90 | 1.55 | 0 |
| Retardation film 19 | 146 | 90 | 1.56 | 0 |

### <Production of Linear Polarizer>

A linear polarizer was produced through the following procedure.

### (Production of Cellulose Acylate Film 1)

### —Production of Core Layer Cellulose Acylate Dope—

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl substitution degree of 2.88 | 100 | parts by mass |
| Polyester compound B described in Examples of JP2015-227955A | 12 | parts by mass |
| Compound F shown below | 2 | parts by mass |
| Methylene chloride (first solvent) | 430 | parts by mass |
| Methanol (second solvent) | 64 | parts by mass |

Compound F

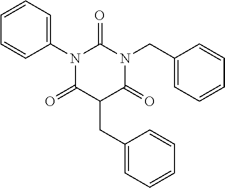 [SMILES: O=C1C(Cc2ccccc2)C(=O)N(c2ccccc2)C(=O)N1Cc1ccccc1]

### —Production of Outer Layer Cellulose Acylate Dope—

10 parts by mass of the following matte agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles with average particle size of 20 nm | 2 | parts by mass |
| (AEROSIL R972, manufactured by Nippon | | |
| Aerosil Co., Ltd.) | | |
| Methylene chloride (first solvent) | 76 | parts by mass |
| Methanol (second solvent) | 11 | parts by mass |
| Core layer cellulose acylate dope shown above | 1 | part by mass |

### —Production of Cellulose Acylate Film 1—

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were immobilized by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 1. The in-plane retardation of the obtained cellulose acylate film 1 was 0 nm.

### <Formation of Photo-Alignment Layer PA1>

The cellulose acylate film 1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1. A film thickness thereof was 0.3 μm.

(Coating liquid S-PA-1 for forming alignment layer)

| | | |
|---|---|---|
| Polymer M-PA-1 shown above | 100.00 | parts by mass |
| Acid generator PAG-1 shown above | 5.00 | parts by mass |
| Acid generator CPI-110TF shown above | 0.005 | parts by mass |
| Xylene | 1220.00 | parts by mass |
| Methyl isobutyl ketone | 122.00 | parts by mass |

### <Formation of Light Absorption Anisotropic Layer P1>

The obtained alignment layer PA1 was continuously coated with the following coating liquid S-P-1 for forming a light absorption anisotropic layer with a wire bar to form a coating layer P1. Next, the coating layer P1 was heated at 140° C. for 30 seconds and cooled to room temperature (23° C.). Next, the coating layer P1 was heated at 90° C. for 60 seconds and cooled to room temperature again. Thereafter, the coating layer P1 was irradiated with an LED lamp (central wavelength of 365 nm) for 2 seconds under an irradiation condition of illuminance of 200 mW/cm², thereby forming a light absorption anisotropic layer P1, which is a linear polarizer, on the alignment layer PA1. A film thickness thereof was 1.6 μm.

Composition of coating liquid S-P-1 for forming light absorption anisotropic layer

| Dichroic substance D-1 shown below | 0.25 | parts by mass |
|---|---|---|
| Dichroic substance D-2 shown below | 0.36 | parts by mass |
| Dichroic substance D-3 shown below | 0.59 | parts by mass |
| Polymer liquid crystalline compound M-P-1 shown below | 2.21 | parts by mass |
| Low-molecular-weight liquid crystalline compound M-1 shown below | 1.36 | parts by mass |
| Polymerization initiator | | |
| IRGACURE OXE-02 (manufactured by BASF SE) | 0.200 | parts by mass |
| Surfactant F-3 shown below | 0.026 | parts by mass |
| Cyclopentanone | 46.00 | parts by mass |
| Tetrahydrofuran | 46.00 | parts by mass |
| Benzyl alcohol | 3.00 | parts by mass |

Dichroic substance D-1 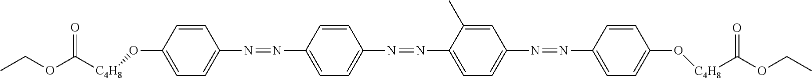
Dichroic substance D-2 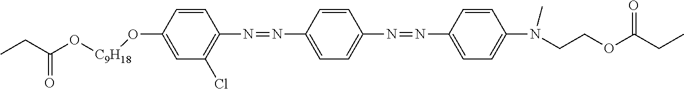
Dichroic substance D-3 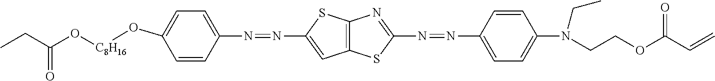
Polymer liquid crystalline compound M-P-1 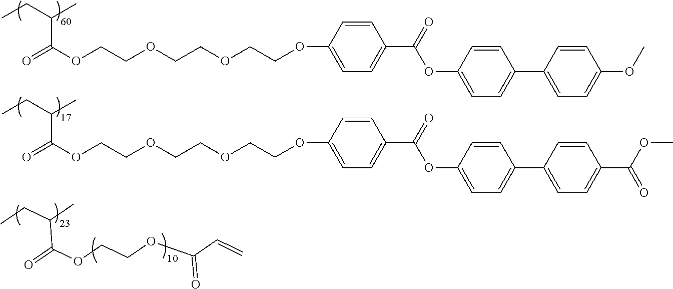
Low-molecular-weight liquid crystalline compound M-1 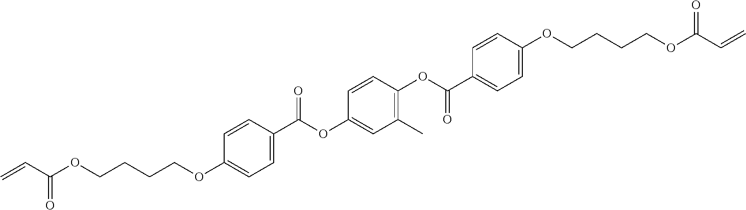 [SMILES: C=CC(=O)OCCCCOc1ccc(C(=O)Oc2ccc(OC(=O)c3ccc(OCCCCOC(=O)C=C)cc3)c(C)c2)cc1]
Surfactant F-3

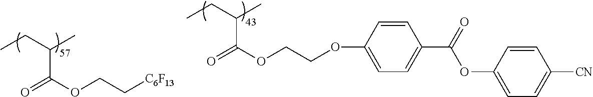

### [Production of Laminated Optical Film 1]

A broadband dielectric multilayer film (trade name: APF, 3M Company) was used as a linear reflective polarizer. A UV adhesive Chemi-seal U2084B (manufactured by ChemiTech Inc., refractive index n after curing n: 1.60) was applied onto the one surface of the broadband dielectric multilayer film using a wire bar coater such that the thickness was set to 2 μm. The retardation film 1 was bonded thereon using a laminator so that the opposite side of the temporary support was in contact with the UV adhesive. After nitrogen purging until the oxygen concentration reached 100 ppm or less in a purge box, the retardation film 1 was cured by being irradiated with ultraviolet rays using a high-pressure mercury lamp from the temporary support side. The illuminance was 25 mW/cm² and the irradiation amount was 1,000 mJ/cm². After the curing, the temporary support was peeled off. In addition, the light absorption anisotropic layer P1 was transferred to a surface of the broadband dielectric multilayer film opposite to the retardation film 1 by the same procedure as described above. The light absorption anisotropic layer P1 side of the completed film was bonded to a PMMA film having a film thickness of 75 μm using the above-described UV adhesive Chemi-seal U2084B. In this manner, a laminated optical film 1 consisting of the retardation film 1, the linear reflective polarizer, and the linear polarizer was obtained.

Laminated optical films 2 to 17 and 19 were also produced for the retardation films 2 to 17 and 19 by the same procedure.

### [Production of Laminated Optical Film 18]

A broadband dielectric multilayer film (trade name: APF, 3M Company) was used as a linear reflective polarizer. A UV adhesive Chemi-seal U2084B (manufactured by ChemiTech Inc., refractive index n after curing n: 1.60) was applied onto the one surface of the broadband dielectric multilayer film using a wire bar coater such that the thickness was set to 2 μm. The retardation film 18 was bonded thereon using a laminator so that the opposite side of the temporary support was in contact with the UV adhesive. In this case, the angle was set such that the angle between the reflection axis of the broadband dielectric multilayer film and the slow axis of the retardation film 18 was 15 degrees. After nitrogen purging until the oxygen concentration reached 100 ppm or less in a purge box, the retardation film 18 was cured by being irradiated with ultraviolet rays using a high-pressure mercury lamp from the temporary support side. The illuminance was 25 mW/cm² and the irradiation amount was 1,000 mJ/cm². After the curing, the temporary support was peeled off. Subsequently, a pressure sensitive adhesive (refractive index: 1.49) having a thickness of 5 μm was bonded to a surface of the retardation film 18 opposite to the linear reflective polarizer. The opposite side of the temporary support of the retardation film 17 was bonded to the adhesive such that the opposite side was in contact with the pressure sensitive adhesive. In this case, the angle was set such that the angle between the reflection axis of the broadband dielectric multilayer film and the slow axis of the retardation film 17 was 75 degrees. Thereafter, the temporary support was peeled off. In addition, the light absorption anisotropic layer P1 was transferred to a surface of the broadband dielectric multilayer film opposite to the retardation film by the same procedure as described above, using the UV adhesive Chemi-seal U2084B. The light absorption anisotropic layer P1 side of the completed film was bonded to a PMMA film having a film thickness of 75 μm using the above-described UV adhesive Chemi-seal U2084B. As a result, a laminated optical film 18 consisting of the retardation film 17 (Re(550)=146 nm), the retardation film 18 (Re(550)=292 nm), the linear reflective polarizer, and the linear polarizer was obtained. Since the laminate in which the retardation film 17 (Re(550)=146 nm) and the retardation film 18 (Re(550)=292 nm) were laminated at the above-described angles had the performance of the 24 plate having a wide range, a laminated optical film having a λ/4 plate in a wide range was obtained.

### [Formation of Half Mirror on Lens]

A convex surface side of the lens (convex meniscus lens LE1076-A (diameter: 2 inches, focal length: 100 mm) manufactured by Thorlabs, Inc.; a laminated optical film 2 was bonded to the concave surface side) was subjected to aluminum vapor deposition so that the reflectivity was 40%, thereby forming a half mirror.

### [Molding Method]

The laminated optical film 1 was set in a molding device. A molding space in the molding device consisted of the box 1 and the box 2, partitioned by the laminated optical film 1, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the laminated optical film 1, with the concave surface facing upward. In addition, a transparent window was installed on the upper part of the box 2 on the upper side of the laminated optical film 1, and an IR light source for heating the laminated optical film 1 was installed on the outside of the box 2. Between the IR light source and the laminated optical film 1, a cholesteric liquid crystal layer which reflects infrared rays with wavelengths from 2.2 μm to 3.0 μm at a reflectivity of approximately 50% was cut into a circular shape having a diameter of 1 inch, and a circular patterned infrared reflecting filter was disposed. In this case, the center portion of the patterned infrared reflecting filter was disposed to be located at the center portion of the mold in a case of being viewed from directly above. Next, each of the inside of box 1 and the inside of box 2 was evacuated to 0.1 atm or less by a vacuum pump. Next, as a step of heating the laminated optical film 1, infrared rays were emitted, and the laminated optical film 1 was heated until the center portion was heated to 99° C. and the end part heated to 108° C. Since the glass transition temperature Tg of the PMMA film used as the support was 105° C., it was intended that the center portion would be less likely to stretch and the end part would be more likely to stretch during the molding. Next, as a step of pressing the laminated optical film 1 against the mold to perform deformation along a shape of the mold, gas was allowed to flow into the box 2 from a gas cylinder to pressurize the laminated optical film 1 to 300 kPa, and the laminated optical film 1 was pressed against the mold. In this case, the laminated optical film 1 was optically bonded to a lens which was a mold through a pressure sensitive adhesive sheet. Finally, the laminated optical film 1 was cut out by cutting out a portion protruding from the lens, which is a mold, to obtain a composite lens 1 in which the laminated optical film 1 molded into a curved surface was bonded to the lens.

The laminated optical films 2 to 19 were also molded into a curved surface by the same procedure.

### [Evaluation of Ghost]

### [Production of Virtual Reality Display Device]

A virtual reality display device “Huawei VR Glass” (manufactured by Huawei Technologies Co., Ltd.), which was a virtual reality display device for which a reciprocating optical system was employed, was disassembled, and all composite lenses were taken out. Instead, the composite lens 1 to which the laminated optical film 1 was bonded was installed such that the laminated optical film came between the composite lens 1 and the eye, thereby preparing a virtual reality display device of Example 1. In this case, the refractive index nA of the adhesive layer at a wavelength of 550 nm used in a case where the laminated optical film 1 was installed on the lens was 1.49, and the average refractive index nL of the retardation layer at a wavelength of 550 nm was 1.63. The square root of the product of these values ((nA×nL)^{1/2}) is 1.56, and since the refractive index of the light interference layer is 1.57, it can be seen that the refractive index of the light interference layer is a preferable value for imparting antireflection ability to the retardation film. In the produced virtual reality display device, a black-and-white checkered pattern was displayed on an image display panel, and ghost visibility was visually evaluated in terms of the following five stages.

Here, the refractive index of the adhesive layer and the average refractive index of the liquid crystal layer were measured with an interference film thickness meter OPTM (manufactured by Otsuka Electronics Co., Ltd., analyzed by the least squares method).

### <Evaluation of Ghost>

A; ghost was not visual at all.
B; ghost was slightly visible, but not noticeable.
C; weak ghost was visible.
D; slightly strong ghost was visible.
E; strong ghost was visible.

Further, virtual reality display devices were prepared by the same procedure using the laminated optical films 2 to 6 and 8 to 16 used in Examples 2 to 4, 6 to 10, and Comparative Examples 1 to 6. The refractive index nA of the adhesive layer at a wavelength of 550 nm used in a case where the laminated optical films 2 to 6 and 8 to 16 were installed on the lens was 1.49, and the average refractive index nL of the retardation layer at a wavelength of 550 nm was 1.63. The square root of the product of these values ((nA×nL)^{1/2}) is 1.56, and since the refractive index of the light interference layer is 1.57, it can be seen that the refractive index of the light interference layer is a preferable value for imparting antireflection ability to the retardation film.

Further, a virtual reality display device was prepared by the same procedure using a laminated optical film 7 used in Example 5. The refractive index nA of the adhesive layer at a wavelength of 550 nm used in a case where the laminated optical film 7 was installed on the lens was 1.49, and the average refractive index nL of the retardation layer at a wavelength of 550 nm was 1.58. The square root of the product of these values ((nA×nL)^{1/2}) is 1.53, and since the refractive index of the light interference layer is 1.55, it can be seen that the refractive index of the light interference layer is a preferable value for imparting antireflection ability to the retardation film.

Further, a virtual reality display device was prepared by the same procedure using the laminated optical films 17 and 18 used in Examples 11 and 12. The refractive index nA of the adhesive layer at a wavelength of 550 nm used in a case where the laminated optical films 17 and 18 were installed on the lens was 1.49, and the average refractive index nL of the retardation layer at a wavelength of 550 nm was 1.58. The square root of the product of these values ((nA×nL)^{1/2}) is 1.53, and since the refractive index of the light interference layer is 1.55, it can be seen that the refractive index of the light interference layer is a preferable value for imparting antireflection ability to the retardation film.

Further, a virtual reality display device was prepared by the same procedure using a laminated optical film 19 used in Example 13. The refractive index nA of the adhesive layer at a wavelength of 550 nm used in a case where the laminated optical film 19 was installed on the lens was 1.49, and the average refractive index nL of the retardation layer at a wavelength of 550 nm was 1.63. The square root of the product of these values ((nA×nL)^{1/2}) is 1.56, and since the refractive index of the light interference layer is 1.56, it can be seen that the refractive index of the light interference layer is a preferable value for imparting antireflection ability to the retardation film.

Table 2 shows the types of the retardation films and the laminated optical films used in each of Examples and Comparative Examples. In addition, the evaluation results of the ghost visibility are shown in Table 2.

As a result, in the virtual reality display devices of Comparative Examples 1 to 6, the light of the white display region was partially visually recognized as a strong ghost in the black display region of the checker pattern. On the other hand, in the virtual reality display devices of Examples 1 to 13 in which the retardation film, in which the light interference layer satisfying the predetermined condition was disposed, was used, it was confirmed that the ghost was improved. In addition, in Example 13 in which the film thickness of the light interference layer was 90 nm and the difference between the refractive index of the light interference layer and (nA×nL)^{1/2} was 0.00, it was confirmed that the ghost was improved to a level that was slightly visible but not noticeable.

Table 2. Evaluation results of retardation film and ghost used in Examples and Comparative Examples

TABLE 2

| | | | Ghost |
|---|---|---|---|
| | Retardation film | Laminated optical | visi- |
| | to be used | film to be used | bility |
| Example 1 | Retardation film 1 | Laminated optical film 1 | C |
| Example 2 | Retardation film 2 | Laminated optical film 2 | D |
| Example 3 | Retardation film 3 | Laminated optical film 3 | D |
| Example 4 | Retardation film 4 | Laminated optical film 4 | D |
| Comparative | Retardation film 5 | Laminated optical film 5 | E |
| Example 1 | | | |
| Comparative | Retardation film 6 | Laminated optical film 6 | E |
| Example 2 | | | |
| Example 5 | Retardation film 7 | Laminated optical film 7 | D |
| Comparative | Retardation film 8 | Laminated optical film 8 | E |
| Example 3 | | | |
| Example 6 | Retardation film 9 | Laminated optical film 9 | D |
| Example 7 | Retardation film 10 | Laminated optical film 10 | D |
| Example 8 | Retardation film 11 | Laminated optical film 11 | D |
| Comparative | Retardation film 12 | Laminated optical film 12 | E |
| Example 4 | | | |
| Comparative | Retardation film 13 | Laminated optical film 13 | E |
| Example 5 | | | |
| Example 9 | Retardation film 14 | Laminated optical film 14 | D |
| Example 10 | Retardation film 15 | Laminated optical film 15 | D |
| Comparative | Retardation film 16 | Laminated optical film 16 | E |
| Example 6 | | | |
| Example 11 | Retardation film 17 | Laminated optical film 17 | D |
| Example 12 | Retardation film 18 | Laminated optical film 18 | D |
| Example 13 | Retardation film 19 | Laminated optical film 19 | B |

### EXPLANATION OF REFERENCES

10, 11: retardation film
21: retardation layer
22: light interference layer
23: adhesive layer
100: laminated optical film
101: adhesive layer
102: linear reflective polarizer
103: adhesive layer
104: linear polarizer
300: half mirror
400: circular polarizer
500: image display panel
600: lens
1000: ray forming virtual image
2000: ray forming ghost

What is claimed is:

1. A retardation film comprising:
a light interference layer; and
a retardation layer,
wherein the light interference layer and the retardation layer are disposed adjacent to each other in this order to form the retardation film, and
a film thickness of the light interference layer is 60 nm to 110 nm or 230 nm to 330 nm.

2. The retardation film according to claim 1,
wherein a refractive index of the light interference layer in an in-plane direction is 1.50 to 1.70.

3. The retardation film according to claim 2,
wherein the light interference layer is a photo-alignment film.

4. The retardation film according to claim 2,
wherein the light interference layer is a C-plate.

5. The retardation film according to claim 1,
wherein a refractive index of the light interference layer in an in-plane direction is 1.53 to 1.59.

6. The retardation film according to claim 1, further comprising:
an adhesive layer,
wherein the adhesive layer, the light interference layer, and the retardation layer are disposed adjacent to each other in this order to form the retardation film, and
in a case where a refractive index of the adhesive layer is nA and an average refractive index of the retardation layer is nL, a refractive index nI of the light interference layer in an in-plane direction satisfies (nA×nL)^{1/2}−0.03≤nI≤(nA×nL)^{1/2}+0.03.

7. The retardation film according to claim 1,
wherein the light interference layer is a photo-alignment film.

8. The retardation film according to claim 7,
wherein the film thickness of the light interference layer is 60 nm to 95 nm or 230 nm to 330 nm.

9. The retardation film according to claim 7,
wherein the film thickness of the light interference layer is 60 nm to 95 nm.

10. The retardation film according to claim 7,
wherein the film thickness of the light interference layer is 230 nm to 330 nm.

11. The retardation film according to claim 1,
wherein the light interference layer is a C-plate.

12. The retardation film according to claim 11,
wherein a compound having a cinnamoyl group is present between the C-plate and the retardation layer.

13. The retardation film according to claim 11,
wherein the film thickness of the light interference layer is 60 nm to 95 nm.

14. The retardation film according to claim 1,
wherein the light interference layer is a hardcoat layer.

15. A laminated optical film comprising, at least:
a retardation film; and
a linear reflective polarizer,
wherein the retardation film is the retardation film according to claim 1, and the linear reflective polarizer is disposed on a side of the retardation layer opposite to the light interference layer.

16. The laminated optical film according to claim 15, further comprising:
a linear polarizer.

17. The laminated optical film according to claim 16,
wherein the linear polarizer includes a light absorption anisotropic layer which contains at least a liquid crystal compound and a dichroic substance.

18. The laminated optical film according to claim 15, further comprising:
a positive C-plate.

19. The laminated optical film according to claim 15, further comprising:
an antireflection layer.

20. The laminated optical film according to claim 19,
wherein the antireflection layer is a moth-eye film or an AR film.

21. The laminated optical film according to claim 15, further comprising:
a resin base material having a peak temperature of a loss tangent tan δ of 170° C. or lower.

22. An optical article comprising:
the laminated optical film according to claim 15; and
a lens.

23. A virtual reality display device comprising:
the optical article according to claim 22.
